(19) United States
(12) Patent Application Publication
(10) Pub. No.: US 2015/0206441 A1
(43) Pub. Date: Jul. 23, 2015

(54) PERSONALIZED ONLINE LEARNING MANAGEMENT SYSTEM AND METHOD

(71) Applicant: Stephen J. Brown, Woodside, CA (US)

(72) Inventor: Stephen J. Brown, Woodside, CA (US)

(73) Assignee: Invent.ly LLC, Woodside, CA (US)

(21) Appl. No.: 14/201,810

(22) Filed: Mar. 8, 2014

Related U.S. Application Data
(63) Continuation-in-part of application No. 14/158,825, filed on Jan. 18, 2014.

(51) Int. Cl. G09B 5/00; G06Q 50/20

(52) U.S. Cl. CPC G09B 5/00; G06Q 50/2053

(57) ABSTRACT

A system and method for adaptive online learning management for creating and/or publishing customized, personalized, adaptive, and student-specific online course content to enable and provide an efficient learning environment to each student based on the dynamically changing self-evolving student's profile. A student's profile can be created based on factors such as demographic profile, psychographic profile, learning style, personality traits, interests, social networking profile, social media interactions, online interaction characteristics, social networking circle attributes, prerequisite knowledge assessments, social profile, skill, and performance of the student, wherein the student's profile can be processed with respect to a learning object repository to generate a defined set of student-specific learning objects that best suit the profile of the student. A online course content can accordingly be generated based on the defined set of student-specific learning objects.

### CROSS-REFERENCE TO RELATED APPLICATIONS

This application is a continuation-in-part of U.S. Ser. No. 14/158,825 filed on Jan. 18, 2014, the complete disclosure of which, in its entirety, is herein incorporated by reference.

### BACKGROUND

1. Technical Field

The embodiments herein generally relate to online learning management systems for personalized and adaptive student-specific content creation that can be accessed online. The embodiments herein more particularly relate to the creation and/or transmission of student-specific adaptive and personalized online course content.

2. Description of the Related Art

The background description includes information that may be useful in understanding the embodiments herein. It is not an admission that any of the information provided herein is prior art or relevant to the presently claimed embodiments, or that any publication specifically or implicitly referenced is prior art.

Presently, certain educational technology services have been proposed and some implemented to provide teachers, principals, administrators, and other education professionals with tools for teaching skills and materials to students. Some of these tools are software programs that allow student-level interaction and, hence, incorporate instructions that can identify and target weaknesses of a group of students in understanding a topic or mastering a skill set. Although such group-based learning can be helpful to the concerned group of students needing special attention, a major focus of the teaching experience is currently on developing a useful and effective curriculum for the majority of students.

Today, educating students in classrooms primarily occurs through the use of textbooks. Generally, however, a textbook is a static, heavy, boring, two-dimensional, and inefficient way to convey information. Moreover, a textbook can generally do little in the way of teaching students important skills and generally does not enhance the learning experience or offer flexibility in teaching or learning. Also, textbooks are typically not capable of appealing to a broad scope of learners who may have different optimal learning modes than through reading printed text. Because most textbooks use written words, they preferentially address only the linguistic learning style or modality. Textbooks can only be slightly expanded, via the use of graphs and charts, to appeal to students having proclivities toward mathematical or logical modalities. Accordingly, students who process information best via the auditory, musical, and kinesthetic modalities can find textbooks to be an generally non-useful learning tool. Another limitation associated with the use of textbooks relates to their being static and not dynamic. Often times textbooks are out of date before their publication and dissemination to classrooms. The expense associated with updating or providing supplemental materials can be prohibitive for the typical classroom, public or private educational environment.

With more and more users getting connected through heterogeneous devices such as mobile phones, smart phones, tablets, digital TVs, laptops, PCs, etc., online learning management systems (LMS) and content management systems (CMS) are increasingly being used by corporations, government agencies, and educational institutions. An online learning management system is typically a software module that facilitates management and delivery of online content to learners, often in order to enable flexible access to learning content. Typically, an online management system allows for an online teaching environment and can be coupled with a CMS, which can be a computer software system that is typically used to manage, store, control, version, and publish educational content. Using a combination of the above technologies, several educational systems have been developed in the art that offer flexible online learning solutions for educators.

Additionally, online learning systems also attempt to assist students in achieving specific learning goals. However, these online learning systems are generic in nature, wherein all students are presented with the same lecture, content, and assessment regardless of his/her learning style, intelligence, or cognitive characteristics. Even though such content is generated based on varied sources such as prescribed books, teacher developed content, case studies, supplemental notes, third-party content, among other sources; the content, once created, remains stagnant for all students and therefore fails to incorporate factors such as the student's profile, interests, demographic and psychographic attributes, previous performances, devices being used for content consumption, time and location of usage, among other factors, making the content difficult for few learners to perceive and, for few others, making it too easy to comprehend, and hence not resulting into a desired learning experience. Existing solutions also do not typically factor parameters that relate to a student's learning behavior such as the device on which they prefer to learn, time at which they like to read/learn course content, media and format of content that they efficiently process. For example, a student may prefer consuming a video of an ongoing classroom session on his/her internet protocol television (IPTV) and may prefer consuming text content on the move while on his/her tablet on his/her train/bus, and prefer learning through an audio mode through his/her tablet.

Due to the flexible nature of online learning management systems, students can take courses at their own preferred time using different types of electronic devices, at their own pace, and in accordance with their various daily commitments, while educators, management, and human resource departments are able to track progress. Further, because existing systems may be easily updated and modified, learning management systems often provide more relevant information than is currently available using traditional teaching tools. Although one advantage of these courses is the ability to give students key information they need outside the confines of traditional university buildings or classrooms, undefined and unnecessary information can cause an unintended impact and degrade the learning efficiency/performance. This may also lead to situations where students who are struggling with a course are given the same assignments and materials as students who are excelling. Without the ability to create assignments or other course materials that are specifically designed to address the students, many teachers are unable to effectively teach students. Therefore, students whose understanding falls below that of an average student are not given the extra attention that they need, and students who are excelling in a course are not adequately challenged.

Therefore, there is a need for an online learning management for creating and/or publishing student-specific adaptive personalized online course content to enable and provide an efficient learning environment across multiple devices/medias/formats to each student based on a dynamically changing student's profile.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments herein are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments herein are approximations, the numerical values set forth in the specific examples are reported as precisely as practicable. The numerical values presented in some embodiments herein may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the descriptions of the embodiments herein and does not pose a limitation on the scope of the embodiments herein otherwise claimed. No language in the specification should be construed as indicating any non-claimed element essential to the practice of the embodiments herein.

Groupings of alternative elements or embodiments herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

In view of the foregoing, the embodiments herein provide techniques for implementing personalized online adaptive learning management systems by providing and/or enabling transmission of personalized student-specific course content through one or more online means for creation of an efficient learning environment that is designed for each student based on his/her profile, learning attributes, preferences, among other factors.

One embodiment herein provides a method for generating student-specific online course content, the method comprising: generating an electronically represented student profile vector of a student based on attributes representative of one or a combination of a demographic profile, psychographic profile, learning style, personality traits, interests, social networking profile, social media interactions, online interaction characteristics, social networking circle attributes, prerequisite knowledge assessments, social profile, skill, and performance of the student, wherein the student profile vector comprises one or more of the attributes along with associated quantitative values thereof for the student; generating an electronically represented learning objects matrix based on one or more learning objectives of at least one course, wherein each learning objective comprises a plurality of learning objects, and wherein each learning object comprises an electronically represented vector of one or more of the attributes along with weights thereof; processing the student profile vector with the learning objects matrix for the one or more learning objectives to generate an electronically represented student-specific list of learning objects, wherein the student-specific list of learning objects is generated based on values of attributes of the student and weights of corresponding attributes of the learning objects of the learning objects matrix; evaluating the student-specific list of learning objects to select a set of final learning objects from the student-specific list of learning objects; assembling the final list of learning objects; generating the student-specific online course content for the student based on the assembled final list of learning objects; and delivering the student-specific online course content to the student through an online content transmission means.

The processing of the student profile vector with the learning objects matrix may comprise multiplying a value of each attribute of the student profile vector with the weight of each corresponding attribute of learning objects of the learning objects matrix to retrieve the student-specific list of learning objects. The method may further comprise delivering the student-specific online course content in one or a combination of video format, text format, and audio format. The method may further comprise presenting the student-specific online course content to the student in a format and manner defined by the student profile vector. The method may further comprise generating one or more of the plurality of learning objects based on one or a combination of inputs from third-party content providers, content from publishers, online content, shared notes of other students, core course material, supplemental content, case studies, teacher-authored material, curated material, existing literature, student feedback, dynamically retrieved stakeholder content, and dynamically generated relevant content.

The method may further comprise changing the student-specific online course content in real-time based on changes in one or more of the student profile vector and the learning objects matrix. The method may further comprise computing the changes based on feedback, response, or interactions from one or a combination of students, teachers, publishers third-party evaluators, and stakeholders in the student-specific online course content generation. The number of attributes in each learning object that is processed with the student profile vector may be the same as the number of attributes in the student profile vector. One or more learning objects of the learning objective may have different number of attributes. The weight of each attribute across learning objects may be equal. The weight of each attribute across learning objects may be different. The method may further comprise continuously updating the weights of attributes of learning objects for matching between vectors of the learning objects and the student profile vector.

The weight of each attribute for the learning object may be based on a relevance of the attribute for the learning object. The assembling of the final list of learning objects may comprise processing a subset of the final list of learning objects. The method may further comprise identifying the learning objectives based on relevance of tasks in a current course, tasks in a previous courses, performance of one or more students in the courses, and interest of one or more students in the courses. The delivering of the student-specific online course content to the student may comprise encrypting the student-specific online course content before transmission to student terminal. The method may further comprise delivering the student-specific online course content to one or more communication devices comprising a mobile phone, tablet computer, personal computer, smart phone, laptop, and display-enabled computing device. The method may further comprise sorting the student-specific list of learning objects to obtain the final list of learning objects. The method may further comprise authorizing the student before delivering the student-specific online course content. The student may form part of a group of students, and wherein the student-specific online course content is delivered to the group of students.

Another embodiment provides a system for generating and delivering student-specific online course content for a student, the system comprising: a student profile vector generation module that generates an electronically represented student profile vector of the student based on attributes representative of one or a combination of a demographic profile, psychographic profile, learning style, personality traits, interests, social networking profile, social media interactions, online interaction characteristics, social networking circle attributes, prerequisite knowledge assessments, social profile, skill, and performance of the student, wherein the student profile vector comprises one or more of the attributes along with associated quantitative values thereof for the student; a first database that stores the student profile vector; an electronically represented learning object matrix creation module that creates a learning objects matrix based on one or more learning objectives of at least one course, wherein each learning objective comprises a plurality of learning objects, and wherein each learning object comprises an electronically represented vector of one or more of the attributes along with weights thereof; a second database that stores the learning objects matrix; a processing module that processes the student profile vector retrieved from the first database with the learning objects matrix retrieved from the second database for the one or more learning objectives to generate a student-specific list of learning objects, wherein the student-specific list of learning objects is generated based on values of attributes of the student and weights of corresponding attributes of the learning objects of the learning objects matrix; and a course content generation module that generates the student-specific online course content for the student based on the student-specific list of learning objects, and delivers the student-specific online course content to the student at a client device through an online content transmission means.

The system may further comprise a prioritization module that selects one or more learning objects from the student-specific list of learning objects to generate the student-specific online course content, wherein the one or more learning objects are selected based on one or a combination of relevance of the learning objects to the student and number of learning objects to be incorporated for generation of the student-specific online course content. The processing module may multiply a value of each attribute of the student profile vector with weight of each corresponding attribute of learning objects of the learning objects matrix to retrieve the student-specific list of learning objects. The student-specific online course content may be delivered in one or a combination of video format, text format, and audio format.

The student-specific online course content may be presented to the student in a format and manner defined based on the student profile vector. One or more of the plurality of learning objects may be generated based on one or a combination of inputs from third-party content providers, content from publishers, online content, shared notes of other students, core course material, supplemental content, case studies, teacher-authored material, curated material, existing literature, student feedback, dynamically retrieved stakeholder content, and dynamically generated relevant content. The student-specific online course content may be adapted in real-time based on changes in one or more of the student profile vector and the learning objects matrix. The changes may be computed based on feedback, response, or interactions from one or a combination of students, teachers, publishers third-party evaluators, and stakeholders in the student-specific online course content generation. The number of attributes in each learning object that is processed with the student profile vector may be the same as the number of attributes in the student profile vector. One or more learning objects of the learning objective may have different number of attributes.

The weight of each common attribute across learning objects may be equal. The weight of each attribute across learning objects may be different. The weights of attributes of learning objects may be continuously updated for matching between vectors of the learning objects and the student profile vector. The weight of each attribute for the learning object may be based on a relevance of the attribute for the learning object. The student-specific online course content delivered to the student may be encrypted before transmission to the client device. The student-specific online course content may be delivered to one or more communication devices comprising mobile phone, tablet electronic device, personal computer, smart phone, laptop, and display-enabled computing device. The student may be authenticated prior to delivering the student-specific online course content.

Another embodiment provides a method for creating adaptive student-specific online course content, the method comprising: generating an electronically represented student profile vector of a student based on attributes representative of one or a combination of a demographic profile, psychographic profile, learning style, personality traits, interests, social networking profile, social media interactions, online interaction characteristics, social networking circle attributes, prerequisite knowledge assessments, social profile, skill, and performance of the student, wherein the student profile vector comprises one or more of the attributes along with associated quantitative values thereof for the student; generating an electronically represented learning objects matrix based on one or more learning objectives of at least one course, wherein each learning objective comprises a plurality of learning objects, wherein each learning object comprises an electronically represented vector of one or more of the attributes along with weights thereof, and wherein the plurality of learning objects are selected based on one or a combination of inputs from third-party content providers, content from publishers, online content, shared notes of other students, core course material, supplemental content, case studies, teacher-authored material, curated material, existing literature, student feedback, dynamically retrieved stakeholder content, and dynamically generated relevant content; processing the student profile vector with the learning objects matrix for the one or more learning objectives to generate an electronically represented student-specific list of learning objects, wherein the student-specific list of learning objects is generated based on values of attributes of the student and weights of corresponding attributes of the learning objects of the learning objects matrix; generating the student-specific online course content for the student based on the student-specific list of learning objects; adapting and updating the student-specific online course content based on one or a combination of changes in the values of the attributes for the student profile vector and changes in the weights of the attributes for learning objects of the learning objects matrix; and presenting the student-specific online course content through a communications network.

The adapting and updating of the student-specific online course content may occur in real-time. The adapting and updating of the student-specific online course content may occur over a period of time based on a regression analysis of weights associated with one or more learning objects of at least one learning objective of one or more courses. The adapting and updating of the student-specific online course content may occur over a period of time based on machine learning implementation on student-specific list of learning objects associated with a plurality of students.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 shows an exemplary online computing architecture of a personalized course content generation system in accordance with an embodiment herein;

FIG. 2 is a schematic diagram showing generation of online student-specific course content in accordance with an embodiment herein;

FIG. 3 is an exemplary architectural layout of a personalized course content generation system in accordance with an embodiment herein;

FIG. 4 illustrates exemplary functional modules configured to implement generation of student-specific course content in accordance with an embodiment herein;

FIG. 5a illustrates exemplary factors based on which a student profile vector can be generated in accordance with an embodiment herein;

FIG. 5b shows the formation of exemplary student profile vectors in accordance with an embodiment herein;

FIG. 6 illustrates generation of a learning object vector in accordance with an embodiment herein;

FIG. 7 illustrates a hierarchical representation of a course repository in accordance with an embodiment herein;

FIG. 8 shows an exemplary illustration of processing a student profile vector with one or more learning objects of a learning objective in accordance with an embodiment herein;

FIG. 9 shows an exemplary representation of a student's online learning interface at a client device in accordance with an embodiment herein;

FIG. 10 illustrates an exemplary method for generation of a personalized course book in accordance with an embodiment herein; and

FIG. 11 illustrates a computer system used in accordance with an embodiment herein.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM®, ColdFire®, GPU, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

One should appreciate that the disclosed techniques provide many advantageous technical effects including configuring and processing various feeds to determine behavior, interaction, management, and response of users with respect to feeds and implement outcome in enhancing overall user experience while delivering feed content and allied parameters/attributes thereof.

The following discussion provides many example embodiments. Although each embodiment represents a single combination of inventive elements, the embodiments herein are considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly described.

The embodiments herein relate to online learning management systems for customized, personalized, adaptive, and student-specific course content creation that can be accessed online to enable online learning, also commonly referred to as e-learning. The embodiments herein more particularly relate to the creation and/or publication of student-specific online course content, which is personalized and is also adaptive to changes in profile and/or characteristics of students. One aspect of the embodiments herein provides a technique for generating a profile vector of a student based on attributes representative of one or a combination of a demographic profile, psychographic profile, learning style, personality traits, interests, social networking profile, social media interactions, content consumption pattern, online/offline activities of his/her registered electronic devices, online interaction characteristics, time of usage, location of usage, online social circle, prerequisite knowledge assessments, social profile, skill, past performance, among other attributes of the student.

A profile vector can be generated based on one or a combination of the above mentioned attributes, which can have different values for different students, and can enable a different profile vector to be created for each student. Based on the student profile vector, a set of online and/or offline student-specific learning objects can be extracted from a repository of learning objects that is created based on one or a combination of data sources such as regular textbooks, content submitted and approved by teachers, publisher's content, third-party content, student generated content, industry-generated content, RSS feeds, blog posts, online course material, extracts from discussion forums, virtual classroom recordings, and publications, among other sources. Such extracted set of online and/or offline student-specific learning objects can be processed and/or aggregated to generate a customized, personalized, and adaptive student-specific online course content for the student, which can then be transmitted to the student for learning and course completion.

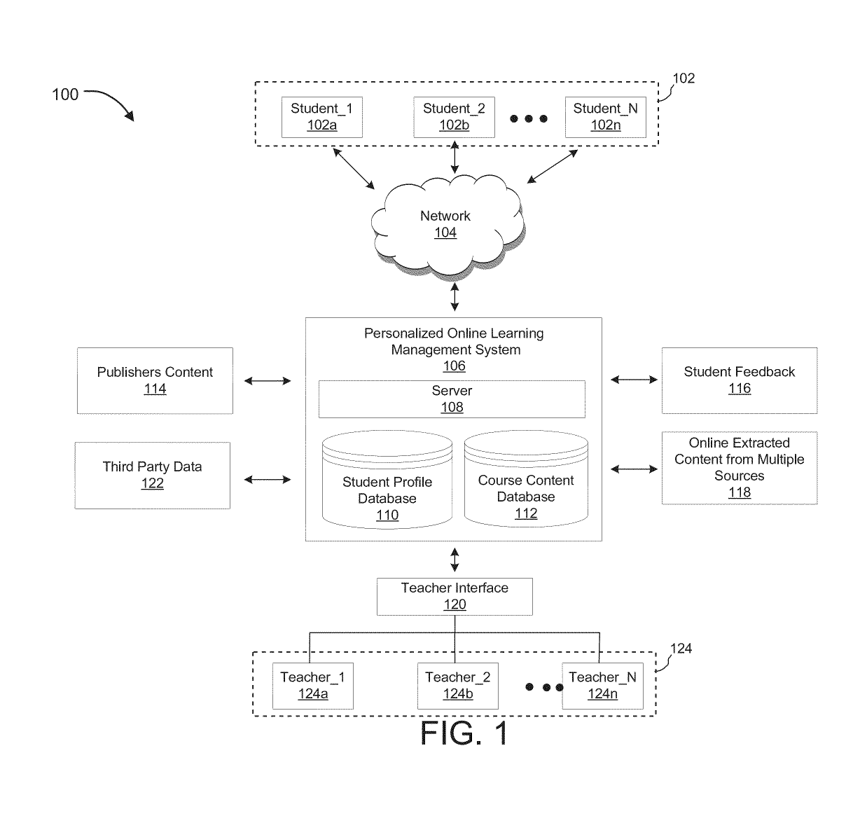

FIG. 1 shows an exemplary computing architecture 100 for generation of an online student-specific course content in accordance with an embodiment herein. In one aspect, system 100 can include multiple content sources including, but not limited to, publishers content 114, student feedback 116, online extracted content from multiple sources 118, third-party data 122, and content supplied by one or more teachers 124a, 124b, . . . , 124n, collectively referred to as teacher 124, through one or more teacher (web) interface(s) 120, among other known sources. One should appreciate that any other known source for generation/modification/processing/finalization of course content is completely within the scope of the embodiments herein. Such other conceivable sources can, for instance, include, student generated content, industry generated content, social media created content, notes shared by other students, core course material, teacher authored material, curated material, other existing literature, among others, which are all within the scope of the embodiments herein. At the same time, content, hereinafter also interchangeably referred to as data, not only includes course content, but can also include relevant case studies, metadata, assessment tools, information objects, RSS feeds, blog posts, extracts from discussion forums, virtual classroom recordings, hierarchy data, survey data, statistical data, course learning objects, among other content from many data sources. One should appreciate that although the embodiments herein describe course content or educational content, any other data or format/type thereof, which may or may not be in the education domain, is within the scope of the embodiments herein. One should also appreciate that although the embodiments herein may describe certain aspects with respect to a single course, content of the embodiments herein can include multiple courses, each having one or more learning tasks/objectives.

According to one embodiment, system 100 can include a personalized online learning management system 106, also interchangeably referred to as POLMS 106 hereinafter, that is operatively coupled with the one or more content sources such as 114, 116, 118, 120, and 122, and can be configured to process and store aggregated content in a course content database 112. In an exemplary implementation, content received from multiple data sources can be categorized, periodically or dynamically, and then aggregated based on the course/subject to which the content pertains. Any other organization or structuring of the course content is completely within the scope of the embodiments herein.

In an embodiment, learning management system 106 can further include a student profile database 110 that is configured to store student profiles of one or more students that are part of the online learning management. Each student profile can be represented, in an implementation, by means of a profile vector that can be generated based on a combination of one or more attributes such as demographic profile, psychographic profile, learning style, personality traits, interests, social networking profile, social media interactions, content consumption pattern, online/offline activities of his/her registered electronic devices, online interaction characteristics, time of usage, location of usage, online social circle, prerequisite knowledge assessments, social profile, skill, past performance, among other attributes of the student. Each such attribute can have a defined value for the student, wherein aggregation of a plurality of such attributes along with their values can enable formation of the profile vector for the respective student. According to one embodiment, database 110 can include such attributes and values thereof of each student in any desired format/architecture, wherein the student profile vector can either be created beforehand and stored or can be generated in real-time when desired. One would appreciate that attributes and values thereof can be stored in any known format such as in the form of different relational or object-oriented database tables. Similarly, course content too can be stored in any desired/known format in the database 112 of the system 106. At the same time, database 110/112 can also be remotely located and accessible to system 106.

In an embodiment, system 106 can include a server 108, which can either be a single computing device or a group of devices operatively coupled with each other or a cloud based computing infrastructure, wherein the server 108 is operatively coupled to databases 110 and 112 can further communicatively coupled, through network 104, with one or more student terminals 102a, 102b, . . . , 102n, collectively referred to as terminal 102 or student 102. In an embodiment, server 108 can aggregate student-specific course content based on processing of student profile vector (from database 110) with learning objects that correspond to course content stored in database 112, wherein the aggregated student-specific course content can then be transmitted through the network 104 to respective student 102. According to one embodiment, student terminal 102 can be any client device including, but is not limited to, a tablet, PC, laptop, mobile phone, smart phone, among any other audio and/or video enabled computing device.

According to another embodiment, from a hierarchical standpoint, content stored in and/or accessible to POLMS 106 can include multiple courses, each course having one or more learning tasks, also interchangeably referred to as learning objectives hereinafter. Each learning objective can further include a plurality of learning objects, which collectively form the respective learning objective. In an aspect of the embodiments herein, each learning object can be represented by means of a vector having one or more attributes with each attribute having a weight associated thereto. Such attributes can include similar attributes as student profile attributes such as demographic attributes, psychographic attributes, learning style attributes, personality related attributes, interest related attributes, social networking profile attributes, social media interactions attributes, content consumption pattern attributes, attributes related to online/offline activities his/her registered electronic devices, attributes related to time of usage, attributes related to location of usage, attributes related to prerequisite knowledge assessments, social profile attributes, preference related attributes, among other attributes. Weights for such attributes can be allocated based on how relevant a given attribute is to the learning object in context. For example, for learning objects of a practical learning objective, such as “analytical chemistry”, “case-studies” based learning style attributes may have higher weights when compared with theory based on learning style attributes.

In another aspect of the embodiments herein, POLMS 106 can be configured to form a learning objects matrix based on one or more learning objectives of at least one course. Learning objects matrix can therefore be a m*n dimensional matrix, having ‘n’ learning tasks/objectives with each objective having ‘m’ learning objects, thereby making a repository of learning objects for a given course. In another aspect, a given learning objects matrix can also be configured to represent multiple courses or parts thereof based on the learning tasks to be included as part of the matrix. One should appreciate that each learning objective can include a different number of learning objects, and each learning object can be represented by a different number of attributes, which may or may not be common with other learning objects. Learning objects matrices can therefore be of different sizes and/or formats depending on the learning objectives being represented therein and the courses or parts therefore that each matrix represents. However, for simpler understanding of the embodiments herein, each learning objects matrix can be assumed to be the same size, wherein each learning object can be assumed to have same number of and common attributes, which have different weights depending on their relevance to the object in context.

In an embodiment, personalized online learning management system 106 can be configured to process a given student profile vector of a given student 102 with a learning objects matrix to generate a student-specific list of learning objects, wherein the student-specific list of learning objects can be generated based on values of attributes of the student profile vector (retreived, for instance, from database 110) and weights of corresponding attributes of the learning object vectors (retreived, for instance, from database 110) of the learning objects matrix. In an implementation, the student profile vector can be multiplied with one or more learning object vectors of respective learning objects of a plurality of learning objectives in order to compute importance values of each learning object for the student in context, based on which an online course content in suitable format (text, audio, video, graphics etc.) can then be generated by the POLMS 106 using the student-specific list of learning objects or a part thereof and transmitted by server 108 to specific student terminal 102. Such online course content can be adaptive in the sense that any change in a student profile vector can impact the content/mode of delivery/time of delivery/mode of the assessment/manner of performance evaluation that is transmitted to each student. For instance, in case a student has changed his/her student terminal 102 from a laptop to a mobile phone, online course content can focus more on delivery of the content in audio format. Such content can also be delivered based on the daily preferred schedule of the student 102 such that if the student, for instance, prefers studying for content in the night (which can be assessed from “preferences” attribute of student profile vector), the content can be pushed only during the preferred study hours. Similarly, in case the online social profile of the student indicates that the student has had a group discussion with his classmates earlier in the day, student profile vector can be updated accordingly, and an assessment based online course content can be generated/pushed to the student through the network 104 to dynamically help him/her revise the discussions on the same subject matter.

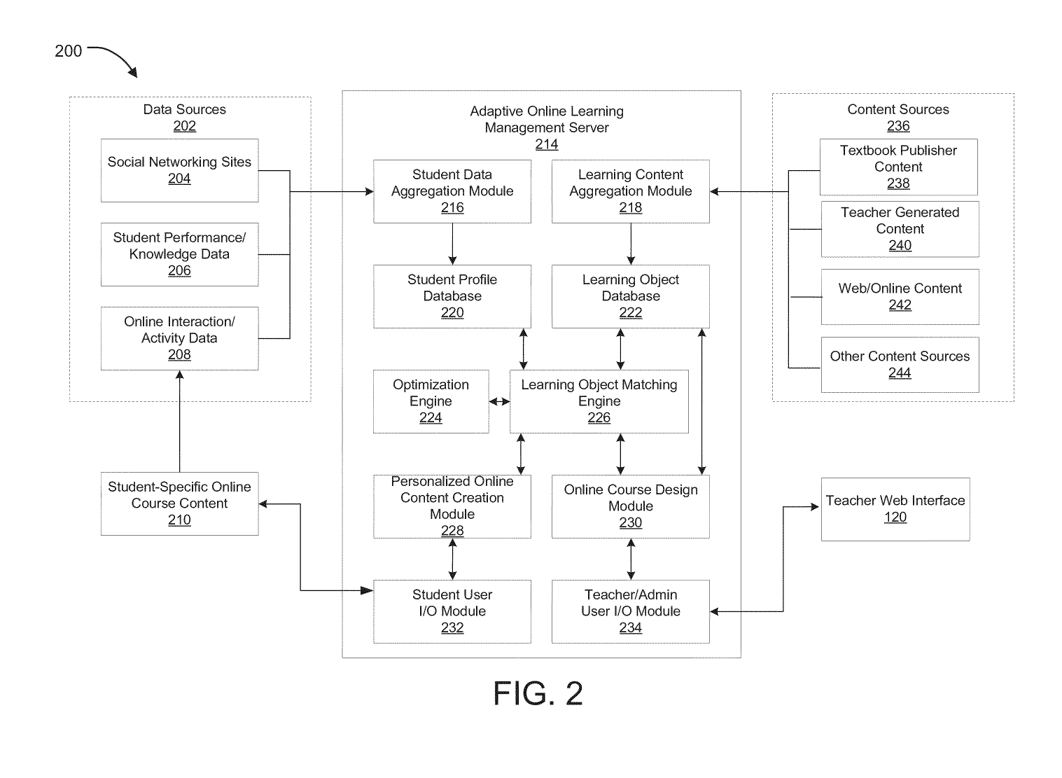

FIG. 2, with reference to FIG. 1, is a schematic diagram of system 200 showing generation of online student-specific course content in accordance with an embodiment herein. In an embodiment, system 200 can include an adaptive online learning management server 214 operatively coupled with course/learning content sources 236 and student profile data sources 202, wherein course content sources 236 include course content provided by multiple stakeholders such as publishers, teachers, students, web content, third-parties, industries, online repositories, among other entities. In one aspect, content sources 236 can include textbook publisher content 238, teacher generated content 240, web/online content 241, and other content sources 244. Such content, as also mentioned above, not only includes actual course material and chapters therein, but also includes assessments, case-studies, metadata, examples, practical scenario's, samples, among others. In an example, teacher generated content 240 can include standard text, supplemental material, instructor authored material, among other content that the concerned faculty is involved with for creation, review, amendments, and publication. Web/online content 242 can include RSS feeds, blog posts, extracts from discussion forums, video data, compilation of classroom recordings, open debates, statistical data, graphics, news, technical journals, patent literature, technical journals, legal proceedings, quizzes, educational tools, other non-patent literatures, product simulation, and post/comments from social networking sites. Web/online content 242 can also include static and dynamically changing data aggregated at frequent pre-defined or dynamic intervals. Other content sources 244 can include, but are not limited to, student notes, student attention data, student quiz performance results, instructor annotations, instructor private notes, and exam results, among other such course material.

Student profile data sources 202, on the other hand, can be configured to include data generated by means of student interaction and/or feedback such as data from social network sites/interactions 204, records of student performance/knowledge data 206, and online interaction and activity data 208. One should appreciate that any other student specific data reflective of demographic profile, psychographic profile, learning style, personality traits, interests, online/offline content consumption pattern, online/offline activities on his/her registered electronic devices, online interaction characteristics, time of usage, location of usage, social networking circle, prerequisite knowledge assessment record, record of skills, among other desired information can be included as part of the data sources 202. In an implementation, as would be shown below, such data sources 202 (indicative of student profiles/preferences/interests/pre-requisite knowledge) can be processed along with content from sources 236 to generate student-specific online content course 210.

According to one embodiment, server 214 can include a student data aggregation module 216 configured to aggregate student-specific information from data sources 202 in order to generate profiles for one or more students 102, wherein such profiles can be stored in student profile database 220. In an embodiment, student profile database 220 can be the same as database 110 of FIG. 1, whereas, in another embodiment, the database 220 may have a different construction/structure when compared with the database 110. In an implementation, each student profile can be represented by means of a student profile vector that comprises one or more attributes reflective of demographic profile, psychographic profile, learning style, personality traits, interests, online/offline content consumption pattern, online/offline activities of his/her registered electronic devices, online interaction characteristics, time of usage, location of usage, social networking circle, prerequisite knowledge assessment records, record of skills, among other student-level parameters. For instance, while creating a student profile vector, social interactions such as comments on social networking websites such as Facebook®, likes on posts, blogs, articles, interactions in discussion forums, level of interactivity in groups such as LinkedIn® groups, type of pictures uploaded, time spent on different pages, among other online behavior can be assessed and incorporated to determine interests, preferences, among other characteristics of one or more students. Each vector can be configured to have a defined number of attributes, which have values associated thereto based on their relevance for the student in context. For example, for a student X, his preferences may indicate more learning efficiency through video-based content when compared with audio-based content, and therefore video-based attributes may have higher values for the respective student 102 when compared with values for audio-based attributes. Similarly, some students may show better performance during group studies with their social circle when compared to learning happening individually. Similarly, some students may like to review course material that is case-based rather then theoretical and therefore objective/subjective values can be associated with a defined number of profile attributes based on the student's past performance, existing knowledge, desired knowledge, preferences, and interests, among other parameters.

According to another embodiment, server 214 can include a learning content aggregation module 218 configured to aggregate content relating to one or more courses from multiple content sources 236 and generate a learning object database 222. Such a learning object database 222, as explained with reference to FIG. 1 (with reference to course content database 112), can include a plurality of learning objects, wherein each educational course can include one or more learning objectives, and each learning objective/task can include one or more learning objects, thereby leading to formation of the plurality of learning objects. According to one embodiment, each learning object can be represented by means of a vector, referred to as learning object vector hereinafter, of attributes along with weights thereof, wherein such attributes are selected from the set of attributes based on which student profile vectors are generated. In an exemplary implementation, dimensionality of each learning object vector can be the same as that of the student vector, enabling efficient processing of each learning object vector of each learning objective/task of each course with respect to the student profile vector.

According to another embodiment, server 214 can include a learning object matching engine 226 that is operatively coupled with student profile database 220 and learning object database 222, and is configured to process the student profile vector of a given student, for example S1, with respect to one or more learning object vectors of at least one course in order to compute and associate an importance value with the one or more learning objects. In an implementation, such learning objects, by means of their respective importance values, can be processed and/or optimized through an optimization engine 224 in order to, for example, prioritize the learning objects or select a subset of learning objects according to the dynamically changing student profile. Optimization engine 224 can select a defined number of (e.g., top 10) learning objects that have the highest relevance based on the student profile vector. According to an embodiment, such a subset of learning objects can then, by means of a personalized online content creation module 228 of the server 214, enable generation of a student specific online course content 210 or any other formatted course book. According to another embodiment, a prioritized list of learning objects can also be used by an online course design module 230 to modify, append, amend, revise, and/or create the online course curriculum so as to make it as specific to the student profile(s) as possible, thereby enhancing the learning experience and overall grasp of course content. Online course design module 230 can be configured to keep track of all the learning objects and student's activity over time and can evolve to present the new course content through a network such as the Internet or an Extranet, and discard obscure contents that have not been visited by a majority of students over long time. Online course design module 230 can also help teachers/academicians to design the course content that is synced with the requirement of the employment/job market. In an aspect, server 214 can further include a content protection module (not shown) that provides access to content only to authorized students. In another aspect of the embodiments herein, the server 214 may also provide a provision to purchase some content that the students do not have access to, such as IEEE, ACM, and science direct papers, and journal articles, etc. The server 214 may suggest reading of some IEEE papers related to one learning object for which the student does not have access to, and provide him/her with an option to purchase the content. In such a case, the server 214 may provide an interface to purchase that content.

In an aspect of the embodiments herein, server 214 can include a student I/O interface module 232 configured to send/share/enable consumption of student-specific online course content 210 by the respective student(s) 102. In an implementation, a given student-specific online course content 210 can be modified at run-time based on the changes in learning object database 222 and/or student profile database 220. The student user I/O interface module 232 can detect the type of electronic devices being used for accessing the online course content and the type of content being accessed. Based on the device type and the content type, student user I/O interface module 232, can then format/reformat the content to better suit the target device. The student user I/O interface module 232 can also have a recommendation sub-module for suggesting relevant content to a user based on the recently accessed content and past history. Through the social media integration, live feeds from multiple sources can directly be presented to student(s) on, for instance, a side panel. According to an embodiment herein, student-specific personalized online course content can be delivered and presented to student in one or a combination of video format, text format, and audio format.

In another aspect of the embodiments herein, server 214 can further include a teacher/administrator/user I/O interface module 234 configured to enable a teacher 112 (of FIG. 1) or any other relevant stakeholder to view, amend, and/or change the course curriculum through teacher (web) interface 120. By means of the teacher/admin/user I/O interface module 234, a user can also support course development programs, which enables an author to create educational content. The teacher/admin/user I/O interface module 234 can further enable learning unit authoring, exam editing, HTML editing, editing of learning objects, editing of online student specific course content, adding more rich media support, attaching more documents, providing scopes, and results. The interface 234 may also provide an author the ability to review the course and the ability to later publish it to online educational management services by means of a synchronization or a similar operation. The teacher/admin/user I/O interface module 234 can also support a collaborative course-authoring environment, where several authors, educators and content providers can work together to develop course content. In one embodiment, the course content may be developed using an educator collaborating online platform, such as Wiki or using any other similar environment where authorized users may download/upload educational content and later create additional content, edit, remove, or change content, which may be uploaded to the educational server later in order to create course content in a collaborative manner.

One should appreciate that system 200 of FIG. 2 can be automated, semi-automated, or can be executed manually in order to generate personalized online course content 210 based on student profile vectors, and at the same time, enable designing of online course curriculum based on processing of a student profile vector with one or more learning object vectors to make the course structure accurate and appropriate for the learning of all students at large.

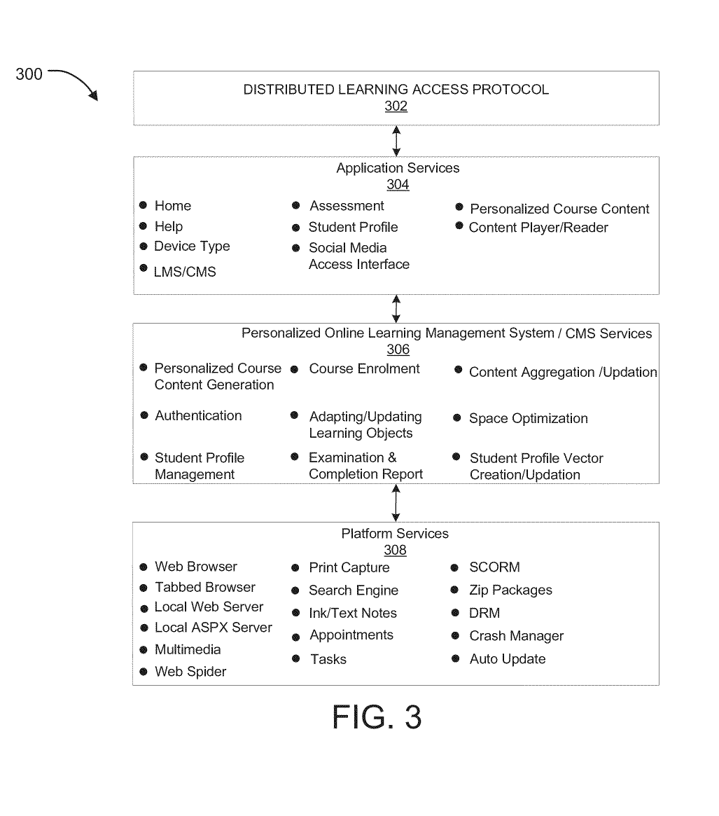

FIG. 3, with reference to FIGS. 1 and 2, shows an exemplary architectural layout of personalized online course content generation system 300 in accordance with an embodiment herein. In an embodiment, system 300 illustrates a distributed access architecture of the learning management system 106 of the embodiments herein, which can broadly be divided into application services 304, POLMS/CMS services 306, and platform services 308. One should appreciate that such architecture is completely exemplary and any other configuration of data/protocols/hierarchy can be implemented. Application services 304 can be operatively coupled with a distributed learning access protocol 302, which provides an interface and access mechanism for a student to access online learning content at their convenience. In one aspect, application services 304 can include, but are not limited to, user interface components (links, buttons, among other selectable items) for accessing links/options such as home page, menu items, toolbars, help, course support, student assessment, student profile, assessment, personalized course contents display, student profile, social media access interface, LMS/CMS interface, option to detect device type, content player/reader, among other application services.

In an embodiment, POLMS/CMS services 306 relate to server level applications used for implementation and execution of the learning management system 106. Services 306, in an embodiment, can include, but are not limited to, personalized course content generation based on one or more student profile vectors and learning objectives, course enrolment services for selecting and enrolling student(s) for one and more courses to be completed based on self-selection or system recommendation, content aggregation/updation services for collecting relevant content from multiple sources through different interfaces based on given learning objectives and student profiles, authentication services for authenticating students, teachers, publishers and other third party content provider and/or content consumer, student profile management services for maintaining a student's credentials and profiles based on the above described parameters. Services 306 can further include services for adapting/updating learning objects automatically or manually, services for examination and competency assessment of students, services for customized course design for a group of students having a common interest or similar profile, among other like services and/or features that are desirable to be supported by the learning management system 106 of the embodiments herein.

In another embodiment herein, platform services 308 represent architecture/hardware/firmware level foundation level features over which functional features/applications/services of system 306 can be implemented. Platform services 308 can include, but are not limited to, a web browser, tabbed browser, local web server, local ASPX server, web spider, web crawler, print capture, searching engine, ink/text notes, appointment manager, task manager, SCORM, Zip packages, DRM, crash manager, auto updates, among other like services 308. The platform services 308 are core components upon which POLMS/CMS services 306 can be provided, and on which one and more third party applications can be built. According to an embodiment herein, one and/or more POLMS/CMS services 306 can be provided independently as a provider services or as a SAAS through cloud. In addition, these services 306 can include a web browser, HTML 5 application platform, audio/video player, flash player, QuickTime, download manager, and a streamer that can enable the content to be consumed on any device at any time in a suitable format.

In an aspect of the embodiments herein, in order for distributed learning applications to work, a set of APIs can be provided from the POLMS or CMS system services 306 as web services that can deliver high performance to the applications built on the system 300. These APIs can be used for providing one and more application services and POLMS/CMS services 306 by third parties, for data collection from social media platforms and other online and offline sources. In an implementation, a web services-based protocol such as Distributed Learning Access Protocol (DLAP) can be used between any distributed learning clients and any LMS or CMS server. It is designed for very high performance that supports DRM-secure communications, and supports both learner's and teacher's activities. The system 300 can include DLAP and related methods of permitting future third-party online e-Learning systems to use defined application program interfaces that will facilitate interoperability and standardization.

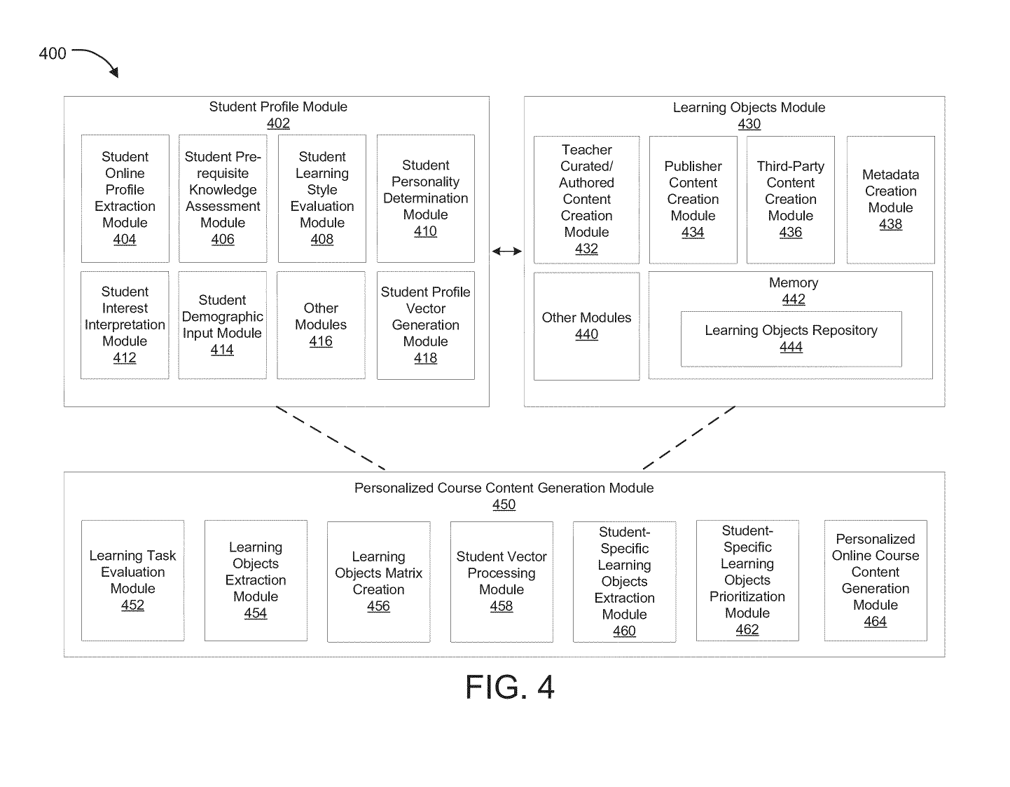

FIG. 4, with reference to FIGS. 1 through 3, illustrates exemplary functional modules 400 configured to implement generation of student-specific online course content for distribution and/or transmission of the course content to students that are remotely located and positioned. In an exemplary embodiment, functional modules 400 can include a student profile module 402, a learning objects module 430, and a personalized course content generation module 450, which are operatively coupled with each other and can be implemented on a single computing device or a combination of different devices that are remotely connected with each other, or in a distributed system architecture as illustrated in FIG. 3. Moreover, the specific modules associated with each of the modules 402, 430, 450 (e.g., modules 404-418 associated with the student profile module 402; modules 432-440 associated with the learning objects module 430; and modules 452-464 associated with the personalized course content generation module 450) are respectively operably coupled with each other and can be implemented on a single computing device or a combination of different devices that are remotely connected with each other or in a distributed system architecture as illustrated in FIG. 3.

According to one embodiment, student profile module 402 can be configured to generate a student profile vector for a student 102 based on student attributes such as profile, interests, social interactions, preferences, learning styles, among other attributes that can define the learning/content consumption pattern, preferences/interests/learning style of the student, and what and how the student 102 may be more inclined to study efficiently for improvement in performance. In an exemplary embodiment, module 402 can further incorporate one or more modules including, but not limited to, student online profile extraction module 404, student pre-requisite knowledge assessment module 406, student learning style evaluation module 408, student personality determination module 410, student interest interpretation module 412, and student demographic input module 414, among other modules 416 that can be configured to incorporate multiple attributes (or types thereof) of a plurality of students and associate values to one or more attributes, based on which student profile vector generation module 418 creates the student profile vector.

According to one embodiment, module 404 can be configured to extract online attributes relating to one or more students, and evaluating each student based on the extracted set of online attributes. Such evaluation can either be performed automatically through mechanisms such as crawling or can be done manually to comprehensively evaluate student's online interactions such as at Facebook®/Twitter®/LinkedIn®, activities such as comments posted, number of likes, type of blogs/articles/publications, areas of interest while browsing, average time spent on each page, time of day when browsing is performed, type of applications accessed, type of data/content generated, among many other allied parameters. One should appreciate that attributes based on which values are associated to generate a student profile vector can either be the same for each student or can be different. For instance, the number of attributes for a student who is very active on social media may have a larger number of attributes when compared to another student who is not as actively involved in online interactions.

According to another embodiment, student prerequisite knowledge assessment module 406 can be configured to evaluate prerequisite knowledge of one or more students in order to associate attributes based on the prerequisite knowledge assessment to reflect courses of importance for each student 102 along with indicating the past performance and understanding the level of students 102 with respect to various learning objectives/tasks and learning objects. Prerequisite knowledge with respect to one or more learning objectives for a given student 102 can also help identify and correlate values of various attributes associated with the past performance and knowledge/learning level of the student 102. For example, for a learning objective such as polynomials, different values can be coupled with attributes of the prerequisite knowledge for each student 102 based on the previous performance and current knowledge level of student 1 and student 2.

According to another embodiment, student learning style evaluation module 408 can be configured to evaluate learning styles of one or more students in order to associate attributes (along with values thereof) based on the learning styles and habits of the students so as to identify the mode of teaching, such as case-based, concrete experience based, abstract conceptualization based, discovery based, hands-on and concert based, theoretical, practical exercises based, among others, through which a given student 102 would have an efficient learning experience. The learning style for a student can relate to one's natural or habitual pattern of acquiring and processing information in learning situations. As different models have been proposed for evaluating learning styles of students such as David Kolb's model, Peter Honey and Alan Mumford's model, among others, any or a combination these models can be used to evaluate each student 102 and identify a common set of attributes for all students 102 so that values can be associated to such attributes based on the learning styles prevalent with each student 102.

According to an implementation, the learning style for one or more students 102 can be evaluated based on their measure on attributes relating to one of the four categories, namely, accomodators, converger, diverger, and assimilator. One should appreciate that each student 102 can have attributes that are a combination of two or more of the above mentioned categories, wherein accomodators typically relate to users who believe in concrete experience and active experiments, whereas convergers focus more on abstract conceptualization and active experiments, and divergers relate more to concrete experience and reflective observation based on learning, and assimilators are more apt to abstract conceptualization and reflective observation based knowledge enhancement. Any other model can also be used, independently or combined with other known models, to define one or more learning style based attributes, and assign values to each student 102 based on such defined learning style based attributes.

According to another embodiment, student personality determination module 410 can be configured to evaluate personality and traits related attributes of one or more students 102 in order to associate values to such attributes based on behavioural traits, social traits, attitude related attributes, ability/skills related attributes, temperament/energy/responsibility/initiative/leadership/punctuality related attributes. Personality attributes can play a significant role in determining the type, mode, and kind of content that a student 102 would like to receive and efficiently process for desired learning.

Student interests interpretation module 412, on the other hand, can be configured to identify interests, preferences, and hobbies for each student 102 and process such interest-based data to associate values with attributes that define such interests at a common level for one or more students 102. According to one embodiment, social interactions, social networking patterns, friends circle, type of network connections, type of videos viewed, daily routine, electronic device used for content consumption, content format preferences, among other factors can help define interests and personality attributes of one or more students 102, which can then be evaluated based on a set of defined attributes by associating values with each attribute of the set.

According to one embodiment, student demographic input module 414 can be configured to incorporate a list of demographic attributes in which one or more students 102 in context can be assessed/profiled. Demographic attributes can include, but are not limited to, age, gender, generation, race, ethnicity, education background, qualifications, geographic region, marital status, among other attributes. Upon generation of a list of demographic attributes, module 414 can be configured to evaluate a student 102 on one or more attributes and associate a value based on the same. In an embodiment, one or more demographic attributes can be combined to form a defined number of common attributes, wherein values of each attribute can then be associated for each student 102. For example, students with a weaker academic background can be associated with a higher/lower value for attribute A in order to indicate a stronger need to learn certain courses (or learning objectives within a given course).

According to one embodiment, student profile vector generation module 418 can be configured to generate a student profile vector of a student 102 based on attributes representative of one or a combination of a student's demographic profile, psychographic profile, learning style, interests, prerequisite knowledge assessments, social profile, online interactions, online behavior, content consumption pattern, electronic devices being used, time and location of use, preferred format, skills, performances, among other parameters/factors defined by other student profile indicating module 416, wherein the student profile vector can include a defined set of attributes along with values thereof for the given student 102. In an example, student profile vector for a student S₁ can include a defined set of, for example six attributes (A₁ to A₆), which may or may not be common across other students S₂ to Sₙ, wherein each of the six attributes for any given student can have a defined value; e.g., V₁ to V₆, which collectively are indicative of the student's profile. Similarly, the second student, S₂, can have different values associated with the same attributes (A₁ to A₆). In an implementation, a second student, S₂, can also have a different set of attributes or additional attributes along with values thereof for the second student, S₂, based on which a different student profile vector can be generated.

According to one embodiment, learning objects module 430 can be configured to create a repository 444 of learning objects that can be stored in a memory 442 of the system 400. The memory 442 can either be internal to the system/server 400 or can be located remotely for being accessed by one or more servers. In an embodiment, repository 444 can be configured to store learning objects for one or more courses, wherein each course can include at least one learning objective/task and each learning objective/task can be defined by means of a plurality of learning objects. According to one embodiment, module 430 can include one or more of a teacher curated/authored content creation module 432, publisher content creation module 434, third-party content creation module 436, metadata creation module 438, among other modules 440 that are configured to create, modify, review, amend, collate, and aggregate course content from multiple online and offline sources such as teachers, online and offline third parties, publishers, students, industry, among other stakeholders. According to one embodiment, learning objects can be organized in a hierarchy that is based on the skill level associated with the learning objects. The learning objects can also be made to compete with one another for a spot in the hierarchy so that the “best” learning object can be recommended more often. Learning objects, in addition to representing course content, can also include one or a combination of metadata, case studies, practical examples, exercises, assessments, relationships with other learning objects of a given learning objective, skills hierarchy data, information objects, among other type or cast of content. Online generated content through blogs, articles, newsletters, views, and comments can also be incorporated to enhance the real-time learning experience of the concerned students.

According to one embodiment, each learning object can be represented by means of a vector having a defined set of attributes having weights associated with each attribute based on the learning object in context. In an implementation, the number of attributes based on which the student profile vectors are generated can be the same as the number of attributes based on which each learning object vector is instantiated. For example, in case a student profile vector is represented through four attributes such as interests, learning style, prerequisite knowledge, and skills; the same set of four attributes can be used for representation of the learning object vector as well, wherein weights can be associated with each attribute of the learning object vector based on the learning object in context.

The personalized online course content generation module 450 can be configured to generate student specific online course content 210 based on the student profile vector and one or more learning objects. According to one embodiment, module 450 can include a learning task evaluation module 452, a learning objects extraction module 454, a learning objects matrix creation module 456, a student vector processing module 458, a student-specific learning objects extraction module 460, a student-specific learning objects prioritization module 462, and a personalized online course content generalization module 464, one or more of which are operatively coupled with each other to assist in generation of personalized course content based on student profile vector(s) and learning object(s). One or more of these modules can be implemented on a plurality of servers 108 such that the generated student-specific online course content can be transmitted to one or more client/student terminals, either at defined intervals or dynamically at run-time.

According to one embodiment, learning task evaluation module 452 can be configured to evaluate the course and learning objectives that a student 102 wishes to undergo as part of a curriculum or even otherwise. Such tasks/courses can be selected either automatically or can be explicitly selected by the student 102 through his client terminal by means of the user interface (UI) of the system 106. Such an interface can either be a web-based interface or can be an application that is installed and run on the computing device. Once a course is chosen by a student 102 or is expected to be taken by the student 102, one or more learning objectives that form part of the selected course can be retrieved and then evaluated to select the final set of learning objectives that may be most relevant for the student 102 based on the student profile. In one aspect, such evaluation can be performed automatically based on a student profile, prerequisite knowledge, previous courses taken, desired learning, future objectives, among other factors.

According to one embodiment, learning objects extraction module 454 can be configured to retrieve and/or extract all learning objects that form part of the learning objective evaluated in module 452. In an alternate embodiment, only a specific type of learning object can be extracted for further analysis and generation of student-specific online course content. In yet another embodiment, only learning objects that are suitable for online transmission/learning can be selected. Such an online course content can include content in any desired format including, but not limited to audio, video, text, animations, and any other format for online and offline content consumption.

According to another embodiment, the learning objects matrix creation module 456 can be configured to create a matrix of learning objects for one or more learning objectives. In an implementation, the matrix of learning objects can be created independently for each learning objective, wherein each learning object of the learning objective can be configured as a row of the matrix and attributes of the learning objects can be configured as columns. Alternatively, learning objects of multiple learning objectives, and even multiple courses or a combination thereof, can be presented in a single learning objects matrix, wherein each matrix represents one or more learning objects along with weights of each attribute by which the learning objects are defined. In another implementation, the learning objects matrix creation module 456 can always be executed and/or performed in any sequence of the system 400, which may be even before the learning objects of a chosen course/learning objectives are extracted by module 454 or even before a given learning objective/course is selected by module 452.

According to another embodiment, student vector processing module 458 can be configured to process the student profile vector of a given student 102 with the learning objects matrix created in module 456 for one or more learning objectives evaluated in module 452 in order to generate a student-specific list of learning objects, wherein the student-specific list of learning objects can be generated based on values of attributes of the student profile vector, and weights of corresponding attributes of the learning objects of the learning objects matrix. In an exemplary implementation, as the dimensionality of each learning object is the same as that of the student profile vector of a given student 102, the learning object vector can be multiplied (e.g., processed) with the student profile vector so as to enable multiplication of each attribute value of the respective student 102 with the weight associated to a corresponding attribute for the learning object in context.

The output of such multiplication can reflect the importance of each processed learning object for the respective student 102, which can help prioritize the output list of learning objects, and enable use one or more of the more relevant learning objects to create the student specific online course content 210. Student-specific learning objects extraction module 460 can then be configured to extract the student-specific learning objects from the output of module 458. In an implementation, such student-specific learning objects can be a subset of learning objects that are chosen based on the output value achieved from the processing between the student profile vector and each learning object vector. For example, the subset of learning objects can be defined as the top half (e.g., ≧50%) of the total number of learning objects in the matrix under consideration such that the top half reflects the highest output values (after processing) as regards to the relevancy of the learning objects for the student 102 in context. Similarly, instead of a percentage, only the top five, most relevant learning objects can be extracted by the module 460. In another alternate embodiment, all learning objects can be extracted along with their respective output values achieved from multiplication of student attribute values with learning object attribute weights.

In an implementation, instead of multiplying vectors of all learning objects in the learning objects matrix with a student profile vector, only a defined number of learning objects can be selected from the objects matrix based on one or more criteria, and then multiplied with the student profile vector to generate a list of student-specific learning objects.

According to one embodiment, student-specific learning objects prioritization module 462 can be configured to prioritize one or more learning objects extracted by module 460 so as to sort the learning objects in order of their relevancy for the student 102a-102n in context. It should be appreciated that module 462 can also be implemented as a sub-module of objects extraction module 460. Prioritization module 462 can therefore enable sorting or any other form of processing of the student-specific learning objects in order to obtain a defined number of learning objects, based on which the online course content 210 can be created. Therefore, on one end, all ranked student-specific learning objects can be prioritized and used accordingly for creation of the online course content 210 and, on another end, only the top and most relevant learning object can be used for creation of the online course content 210.

According to one embodiment, personalized online course content generation module 464 can be configured to incorporate and process a defined number of the most relevant learning objects, and use the same for generation of the personalized online course content. For example, the top three learning objects can be identified as being the most relevant for a student 102, and can then be processed such that the personalized online course content 210 for the student 102 in context, focuses primarily on the final three learning objects. Therefore, although the student-specific online course content 210 can include modules/chapter/text relating to other learning objects as well, the primary focus of the online content 210 can be generated on the most relevant set of learning objects, which does not only relate to course content, but also the manner of giving instructions, focus on case-studies, number of hours required for completing the respective course/learning objective, and need for practical experiments, among other parameters.

In an embodiment, the student personalized online course content 210 can also be coupled with student-specific problem sets and quizzes, which can be delivered automatically based on the student-specific learning objects generated subsequent to processing with student profile vector, wherein the online course content 210 can also be accompanied by supplemental material such as flash cards and annotations, animation, games, quizzes, RSS feeds, new updates. In an embodiment, the student personalized online content 210 can be delivered to him/her in a suitable format based on the electronic device being used by the student and the user interface can be customized accordingly. The course content can either be transmitted to the client terminal in one step, which can then be downloaded and referred for learning, or can be transmitted in parts based on student interaction, performance, and learning style/progress.

In another embodiment, the personalized online course content 210 can also be adapted/updated automatically based on changes in student profile vector(s) and/or learning object vector(s). In an embodiment, as results of students 102 can be accumulated and updated over a period of time, attributes, based on which student profile vector and learning object vectors are formed, can also be updated in terms of their values and weights respectively. System 400 can therefore be configured to dynamically adapt and modify weights associated with various attributes of learning objects in order to keep the representation of learning objects accurate with respect to the learning objective to which it belongs. In an implementation, the learning object vector weights can be adapted such that the updated weights represent actual performance data over a large population of students 102a-102n. Student specific online course content 210 can then be delivered through the Internet to students 102 in a suitable format on his/her connected electronic device including on mobile devices. In another implementation, attention and performance data of students 102 can be used to change/modify/refine weights associated with attributes of learning objects. For example, parameters such as time and attention on a given learning object/objective, sequence through learning objects, usage and choices of supplemental materials, gaps in interaction indicating off-task behavior, patterns on quizzes, repeated hint requests, among other parameters can be used to modify the weights associated with the attributes of learning objects. In yet another implementation, additional contextual data can be collected to further refine the attribute weights, wherein such additional contextual data can include, but is not limited to, additional student profile data, data on other courses currently being attempted by the student(s) 102, data/time of usage, location of content access, electronics device used for content consumption among other contextual factors.

In another exemplary embodiment, teachers and/or publishers can also be allowed to modify student specific online course content 210 once they are generated for each student 102 so as to review and make them more relevant and streamlined with the student's additional attributes that may or may not have been taken into consideration while forming the student profile vector. In other words, by looking at the results of many students 102, optimization on the learning object data can be performed by adjusting the weights associated with attributes of learning objects such that the best performing learning objects for a given personality vector are chosen. Additionally, with individual teachers continuing to add their own knowledge to the creation of content, new and better performing content modules can emerge.

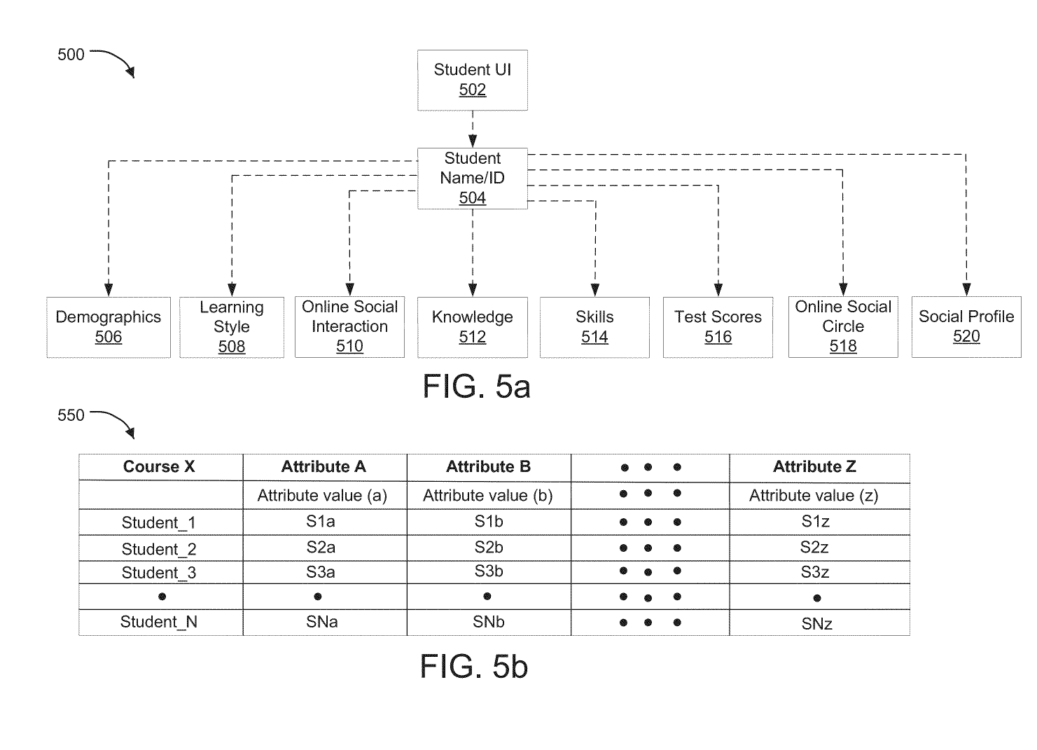

FIG. 5a, with reference to FIGS. 1 through 4, illustrates a factoring system 500 used to generate a student profile vector in accordance with an embodiment herein. As can be seen, the system 500 can include a student user interface (UI) 502 at a client side/terminal by means of which one or more students 102 can interact with the server 108/system 500 to share feedback, content, annotations, preferences, along with submitting their profile attributes across different evaluation parameters in order to enable values to be associated with one or more student-specific attributes. These parameters and their values can be calculated through aggregation of data from multiple sources such as a social media platform, user activity logs on the system 500, online and offline content consumption patterns, data provided by third party and other online and offline data sources. Some of the parameters/attributes used for creating a student profile can include, but are not limited to, demographic attributes 506, learning style based attributes 508, online social interaction based attributes 510, knowledge (pre-requisite knowledge) based attributes 512, skill based attributes 514, test scores 516, online social circle based attributes 518, social profile based attributes 520, among other like attributes. In an example, such online social interaction based attributes 510 can include comments made on social networking websites, type of blogs written, pattern of online browsing, websites browsed, online chats, among other like attributes. Each student 102, also referred to as a user or learner in accordance with the embodiments herein, can be identified through his/her name or an identifier 504 or a combination thereof, wherein each student 102 can be associated with a common or different set of attributes including demographic attributes 506, learning style based attributes 508, online social interaction based attributes 510, knowledge based attributes 512, skill based attributes 514, test scores 516, online social circle based attributes 518, social profile based attributes 520, among other like attributes, values for which can be computed for each student 102 to generate a student's profile vector.

In a similar implementation, learning style 508 can be used as a parameter for quantifying attributes that relate to the learning style of a given student 102. Learning styles 508, in an embodiment herein, can be evaluated by means of a number of Boolean indicators used to signify whether or not a student 102 is related to one of a corresponding number of standard learning styles such as accommodator, converger, diverger, and aasimilator. Learning style approaches can also be evaluated based on, for example, whether the approach is instructionally based, reference based, drill and practice based, exploration and discovery based, tools based, or education game based. Such students can then be rated/valued/graded for one or more attributes that correspond to learning styles, wherein the values can be from, for example, 1 (worst) to 5 (best). Such ratings can also be categorized as education value based, fun based, ease of use based, depth/reusability based, reviewer's opinion based, among other applicable categories.

In a similar implementation, the scope for attributes related to online social interaction 510 can be calculated based on his/her activities on social media sites such as how active he/she is on social media, how frequently he/she is visiting certain topics on social media platforms, his/her blog posting, participation on online discussion forums and comments on relevant subject matters among other parameters. A high or low score can be given for the attribute based on the online social media interaction.

In an example, test scores 516 can be used to determine the characteristics/attributes values of a student 102, wherein in order to assess/quantify such attributes, a testing application can be executed on the student's UI 502 using an online/web application or through executable software provided on a CD-ROM, flash drive, or any other storage or transmission mechanism including wireless transmission means. The score for a test given in an offline mode can be synced once the system 500 is connected to the web. Students can respond to questions generated by the testing application, and responses can be used to determine scores for the students. In another such operating mode, a student 102 may have previously taken a standardized test, results of which can be provided based on the graded standardized test. In some other embodiments, student UI 502 can be presented by means of a third-party computer or mobile phone or tablet (not shown) that is operatively coupled to the Internet through one or more communication means.

FIG. 5b, with reference to FIGS. 1 through 5a, shows the formation of exemplary student profile vectors 550 in accordance with an embodiment herein. In accordance with FIG. 5b, each student, for example Student_1, Student_2, Student_3, . . . , Student_N, can be coupled with a corresponding student profile vector, for example SV_1, SV_2, SV_3, . . . , SV_N, wherein a given student profile vector SV_i can be generated by aggregating a set of common attributes across students along with values of each attribute for the student in context. For example, with reference to FIG. 5b, the vector for each student can be created based on attributes A, B, . . . , Z, wherein the value for each attribute can be different for each student based on the student's profile, demographics, learning style, online social interactions, prior knowledge, skills, test scores, online social circle, social profile, personal preferences, among other above defined parameters/characteristics. In an example, student profile vector SV_1 for Student_1 can be represented as SV_1={S1a, S1b, . . . , S1z}, wherein S1a is the value of attribute A for student S1, S1b is the value of attribute B for student S1, and S1z is the value of attribute Z for student S1. Vectors can similarly be computed for one or more students and appropriately stored.

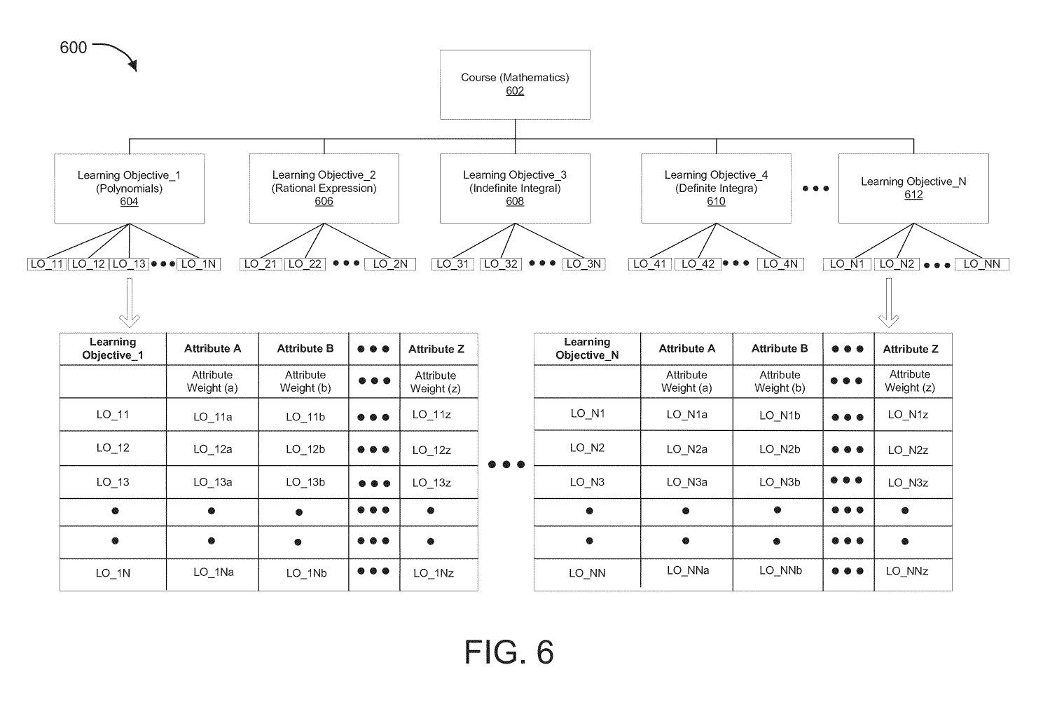

FIG. 6, with reference to FIGS. 1 through 5b, illustrates generation of a learning object vector in accordance with an embodiment herein. As shown, a given course 602, such as mathematics, can include multiple learning objectives such as learning objective_1 (polynomials) 604, learning objective_2 (rational expression) 606, learning objective_3 (indefinite integral) 608, learning objective_4 (definite integra) 610, . . . , and learning objective_N 612. Each course ‘x’ can therefore be expressed as a series of ‘n’ learning tasks, wherein x={ x1, x2, x3, . . . , xn}, where each of x1, x2, x3, . . . , xn represents a learning objective/task. In an implementation, an ideal score of the course can be computed as a sum of ideal score of xi; i.e., sum(ideal_score(xi)). Each learning task xi may require a defined prerequisite knowledge ‘p’, represented by p={ p1, p2, . . . , pn}.

In an embodiment, each learning objective/task xi can include one or more learning objects. In an exemplary implementation, learning task xi can have m learning objects oi, wherein oi={o1, o2, o3, . . . , om}. Assuming each learning task xi of a given course A has ‘m’ learning objects, and that there are ‘n’ learning tasks, the total number of learning objects, which can be represented as a learning objects matrix O would be of the dimensions n*m for the respective course. For example, learning objective_1 can include four learning objects LO_11, LO_12, LO_13, and LO_1N. Similarly, learning objective_2 can include multiple learning objects such as LO_21, LO_22, . . . , LO_2N. Each learning objective can therefore include a different or same number of learning objects based on the course structure, logical modules in each course, possible case-studies involved, and the number of possible assessments, among other parameters.

According to one embodiment, the number of learning objectives of a given course B to be considered for processing with respect to student profile can also be defined based on the aggregate number of tasks in the course B(x), number of tasks (y) of current course B that were already taught properly in previous course, B−1 for example, and the number of tasks (z) of that were part of the previous course B−1 but were not appropriately covered. In such a situation, the total number of tasks to be covered can include x+z−y. Any other characteristic indicative of a prerequisite gap, new content, and tasks that have been mastered can also be incorporated while deciding the total number of tasks/learning objectives to be covered by the student(s) in context. In an alternative embodiment, it is to be noted that mastered prerequisite knowledge or mastered learning tasks may still be included in the text, subject to how the thresholds for defining learning tasks are set.

According to one embodiment, each learning object can be represented by means of a vector having a defined set of attributes having weights associated with each attribute based on the learning object in context. In an implementation, the number of attributes based on which student profile vectors are generated can be the same as the number of attributes based on which each learning object vector is instantiated. For example, in case a student profile vector is represented through four attributes such as interests, learning style, prerequisite knowledge, and skills; the same set of four attributes can be used for representation of the learning object vector as well, wherein the weights can be associated with each attribute of the learning object vector based on the learning object in reference.

A matrix of N*Z can been generated for each learning objective such as Learning Objective_1, wherein each learning object (LO_11, LO_12, LO_13, . . . , LO_1N) of the Learning Objective_1 can be represented through a combination of Z attributes (A-Z), with each attribute being associated with a weight based on the learning object in context. For example, learning object LO_11 can be a vector represented by {LO_11a, LO_11b, LO_11c, . . . , LO_11z}, wherein LO_11a represents the weight of attribute A for learning object LO_11a, and LO_11b represents the weight of attribute B for learning object LO_11. Similar vectors can then also be formed for each learning object of Learning Objective_1. In an implementation, each learning objective can accordingly be processed for each course so as to generate a unique vector that represents each learning object. FIG. 6 shows two exemplary tables showing how vectors can be created for learning objects relating to Learning Objective_1 604 and Learning Objective_N 612. In an aspect, for a learning object that does not have an attribute which is otherwise common for other objects, zero weight can be associated with the attribute for the respective learning object to ensure conformed dimensionality of each learning object, for efficient processing with the student profile vector.

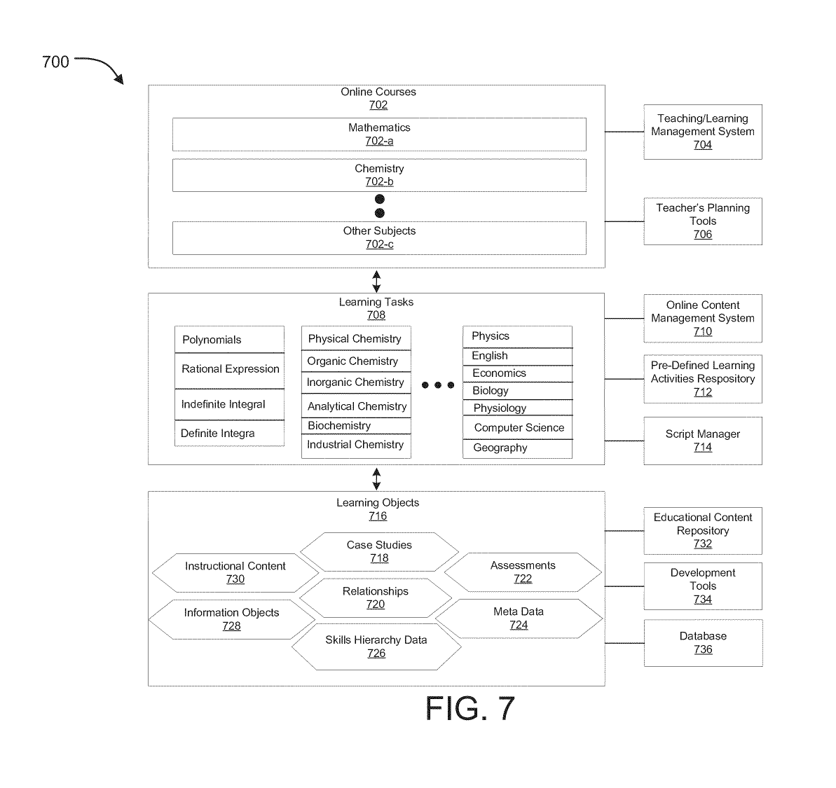

FIG. 7, with reference to FIGS. 1 through 6, illustrates a hierarchical representation of a course repository 700 in accordance with an embodiment herein. As indicated, the course repository 700 can include one or more online courses 702 such as, for example, mathematics 702-a, chemistry 702-b, among and other subjects 702-c to 702-n (not shown), which can be designed, modified, created, and brought to the curriculum based on teaching/learning management systems 704 and one or more planning tools 706. In an implementation, one or more courses 702 can be generated and managed by the system 704, which may create and/or store the courses 702. For example, a browser interface (e.g., teacher interface 120 of FIG. 1) can allow a teacher 124 (of FIG. 1) to browse through learning activities (e.g., sorted or filtered by subject, difficulty level, time length, or other properties), and to select and construct a course by combining one or more learning activities (e.g., using a drag-and-drop interface, a time-line, or other tools). Additionally or alternatively, predefined lessons may be available for utilization by teachers through third-parties and publishers.

Each course 702 can include one or more learning tasks, activities, or objectives 708, wherein for example, a course of mathematics 702-a can include learning objectives such as polynomials, rational expressions, indefinite integral, definite integral, among others. In an exemplary implementation, learning objectives can be managed by means of one or a combination of an online content management system 710, predefined learning activity repository 712, and script manager 714. According to one embodiment, learning tasks 708 can be generated and managed by the online content management system 710, which may create and/or store the learning objectives. Predefined learning activity repository 712, on the other hand, can be configured to store predefined learning activities, which can be utilized by teachers 124 and other stakeholders for editing, modifying, or presenting the content to the students/users/learners 102. The script manager 714, on the other hand, may be used to create, modify and/or store scripts which define the components of the learning activity, their order or sequence, an associated time-line, and associated properties (e.g., requirements, conditions, or the like). Optionally, scripts may include rules or scripting commands that allow dynamic modification of the learning activity based on various conditions or contexts, for example, based on past performance of the particular student 102 that uses the learning activity, based on preferences of the particular student 102 that uses the learning activity, based on the phase of the learning, or the like. Optionally, the script may be part of the teaching/learning plan. Once activated or executed, the script can call the appropriate learning object(s) from the educational content repository 732, and may optionally assign them to students 102; e.g., differentially or adaptively. The script may be implemented, for example, using Educational Modeling Language (EML), using scripting methods and commands in accordance with IMS Learning Design (LD) specifications and standards, or the like. In some embodiments, the script manager 714 may include an EML editor, thereby integrating EML editing functions into the teaching/learning system 704. In some embodiments, the teaching/learning system and/or the script manager 714 utilize a “modeling language” and/or “scripting language” that use pedagogic terms; e.g., describing pedagogic events and pedagogic activities with which teachers 124 are familiar. The script may further include specifications as to what type of data should be stored or reported to the teacher 124 substantially in real time, for example, with regard to students' interactions or responses to a learning object. For example, the script may indicate to the teaching/learning system 704 to automatically perform one or more of these operations: to store all the results and/or answers provided by students 102 to the questions, or to a selected group of questions; to store all the choices made by the student 102, or only the student's last choice; to report in real time to the teacher 124 if predefined conditions are true; e.g., if at least 50% of the answers of a student 102 are wrong, etc.

According to another embodiment, each learning task 708 can include one or more learning objects 716, wherein each learning object 716 can be representative of one or a combination of case studies 718, relationships 720, assessments 722, metadata 724, skills hierarchy data 726, information objects 728, and instructional content 730, among other types of different data. In an embodiment, a learning object 716 for a given learning objective, for example geometry, can be referenced by a learning object identifier, and associated data or references to the associated data may be stored in a relational database such as database 736, and may reference the identifier to indicate that the data is associated with the learning object represented by the identifier.

From another perspective, learning content may be aggregated using a number of learning objects arranged at different aggregation levels, wherein each higher-level learning object may refer to any learning object at a lower level. At its lowest level, a learning object can correspond to content and is not further divisible. In an implementation, course material can include four types of learning objects: a course, a sub-course, a learning unit, and a knowledge item. Starting from the lowest level, knowledge items are the basis for the other learning objects and are the building blocks of the course content structure. Such knowledge items can be stored in repository 732 along with other types of learning objects. Each knowledge item may include content that illustrates, explains, practices, or tests an aspect of a thematic area or topic. Knowledge items typically are small in size (i.e., of short duration; e.g., approximately five minutes or less). Attributes may be used to describe a knowledge item, such as a name, a type of media, and a type of knowledge. Learning units may be assembled using one or more knowledge items to represent, for example, a distinct, thematically-coherent unit. Consequently, learning units may be considered containers for knowledge items of the same general topic. Learning units also may be relatively small in size (i.e., small in duration) though larger than a knowledge item. Sub-courses may be assembled using other sub-courses, learning units, and/or knowledge items. A given sub-course may be used to split up an extensive course into several smaller subordinate courses. Sub-courses may be used to build an arbitrarily deep nested structure by referring to other sub-courses. Courses may be assembled from all of the subordinate learning objects including sub-courses, learning units, and knowledge items. To foster maximum reuse, all learning objects may be self-contained and context free.

Learning objects 716 may be tagged with metadata that is used to support adaptive delivery, reusability, and search/retrieval of content associated with the learning objects. For example, learning objective metadata (LOM) defined by the IEEE “Learning Object Metadata Working Group” may be attached to individual learning objects. A learning objective can be treated as information that is to be imparted by an electronic course, or a subset thereof, to a user taking the electronic course. Learning objective metadata noted above may represent numerical identifiers that correspond to learning objectives. The metadata may be used to configure an electronic course based on whether a user has met learning objectives associated with learning object(s) that make up the course. Other metadata can identify the “version” of the object 716 using an identifier, such as a number. Still other metadata may relate to a number of knowledge types (e.g., orientation, action, explanation, and resources) that may be used to categorize learning objects.

In another embodiment, each learning object 716 can include by way of example and not by way of limitation, assessments, case studies, instructional content, online content, collaboratively developed e-learning content, information objects, relationships, skills hierarchy data, meta data, remediation data, bloom level data, learning object metadata, and object-specific personalized data, wherein the content is said to be “included” as part of a learning object, even though the content may only be referenced by the learning object, but may not actually be stored within a learning object data structure. Content may be stored in an educational content repository 732 and managed by one or more development tools 734. In an embodiment, the content can be “tagged” with metadata describing the content, such as keywords, skills, associated learning objects, the types of learners (e.g. visual) that may benefit from the content, the type of content (e.g. video or audio or text), and statistical information regarding the content usage.

In an implementation, each learning object 716 can be represented as a vector of a set of attributes, each attribute being associated with a weight for the concerned learning object in context. In an embodiment, the number of attributes in each vector of a learning object can be the same as the number of attributes can represent any given student profile vector. In an alternate embodiment, the number of attributes in each learning object can be different, and can also be different from the number attributes that are configured to define student profile vector(s).

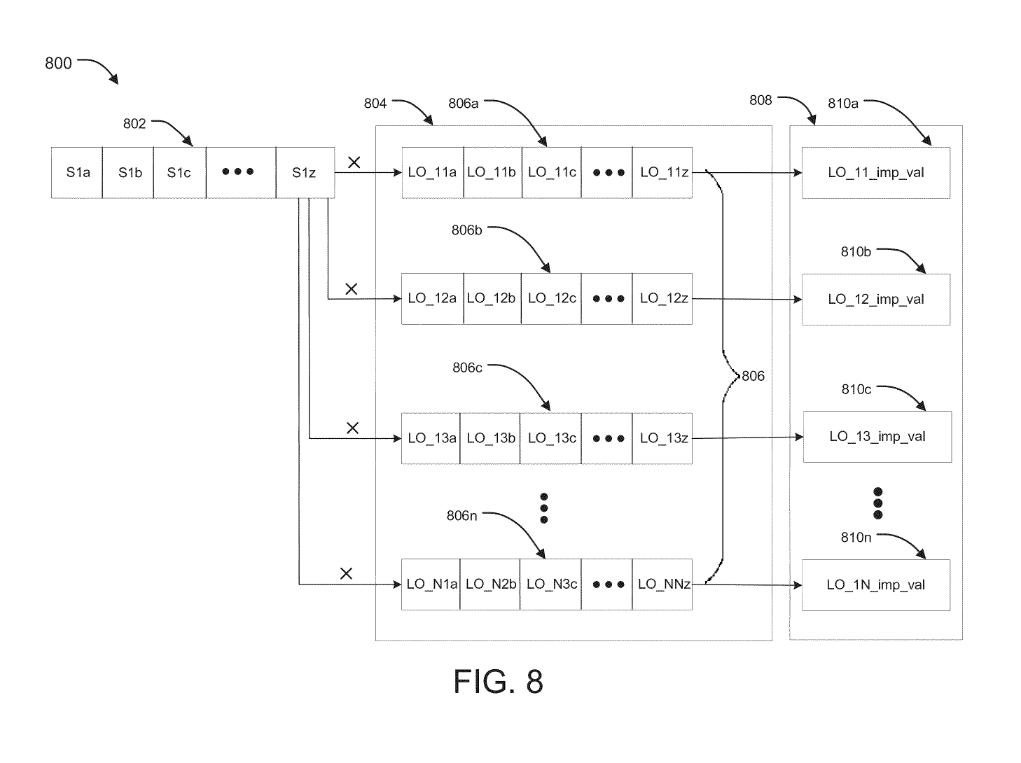

FIG. 8, with reference to FIGS. 1 through 7, depicts an exemplary illustration 800 of processing a student profile vector 802 with one or more learning objects 806 of a learning objective 804. As indicated in FIG. 8, a given student profile vector 802 can be processed with multiple learning objects 806a, 806b, 806c, . . . , 806n, collectively referred to as learning objects 806 hereinafter, of a given learning objects matrix. Although the example implementation in FIG. 8 depicts a learning objects matrix being created for each learning objective 804, it should be appreciated that the matrix can represent any number of learning objectives and/or courses. Furthermore, although the example implementation of FIG. 8 depicts the processing of each learning object of the matrix with the student profile vector 802, it should be appreciated that even a subset of learning objects can be selected from the matrix for multiplication with the student profile vector 802.

A given student profile vector 802 can be multiplied with each learning object vector 806 such that the value of each attribute of student profile vector 802 can be multiplied with the weight of the corresponding attribute of the respective learning object 806. For example, S1a can be multiplied with LO_11a, S1b can be multiplied with LO_11b, and so on, to generate aggregate values of each attribute for the respective student 102, which can then be summed to generate an importance value (LO_11_imp_val) 810a of the respective learning object LO_11 for the given student 102 in context. In an example implementation, LO_11_imp_val 810a represents the importance value of learning object LO_11 for student S1, which can be computed as LO_11_imp_val={S1a*LO_11a+S1b*LO_11b+S1c*LO_11c+ . . . +S1z*LO_11z}. Similarly, the importance values (such as LO_12_imp_val, LO_13_imp_val, LO_14_imp_val, . . . , LO_1N_imp_val) for each learning object 806 can be computed with respect to the student profile vector 802 to generate a list 808 of ‘learning object importance values’.

In an example implementation, once the importance values, also referred to as ‘relevance’ hereinafter, for each learning object have been generated with respect to a given student profile vector, one or more of the learning objects, based on their respective relevance for the student 102, can be processed in order to generate the student specific online course content 210. In an example implementation, instructional content along with metadata, case studies, and examples, of a selected set of relevant learning objects can be processed/aggregated to form the student specific online course content 210. Such a student-specific course content 210 may then be transmitted to the respective student 102a-102n in an appropriate format for online and offline consumption.

In an implementation, weights associated with one or more attributes of a learning object can be updated and/or refitted at defined or dynamic intervals based on accumulated results from one or more of feedback from stakeholders on student-specific online course content, comparison with defined efficiency/learning thresholds, changes in learning pattern/style/traits, among other factors. Such feedback and comments can be aggregated by means of statistical methods of machine learning such as by using regression analysis to determine weights that should be associated with one or more attributes of a learning object or a group of objects. Aggregation of weights for each attribute of a learning object can then help compute the weight of the learning object as well, making it possible to change weights for one or more learning objects based on their interaction with various stakeholders including students. In an instance, such weights can depict the relevance and/or importance that each attribute holds with respect to concerned learning object, and the relevance that each learning object holds with respect to concerned learning objective. In an implementation, feedback from multiple students and their interaction with respective student-specific online course content can be measured and evaluated as part of the aggregated data to help assign and/or dynamically update weights associated with one or more attributes.

In an implementation, in order to compute and assign modified weights to attributes of learning objects, one or a combination of multiple regression techniques can be incorporated to calculate weights that minimize the difference between a predicted set of the most relevant learning objects and the actual results obtained based on aggregation. The embodiments herein therefore intend to enable a minimum difference between actual rankings and predicted rankings for relevance of one or more learning objects. A feedback loop can therefore be established to generate student-specific online course content and then take feedback from multiple entities and stakeholders relating to efficiency/learning styles/pattern/performance, among other metrics, and accordingly modify weights associated with learning objects and/or attributes thereof to assist in generation of more accurate and knowledge/learning enhancing course materials.

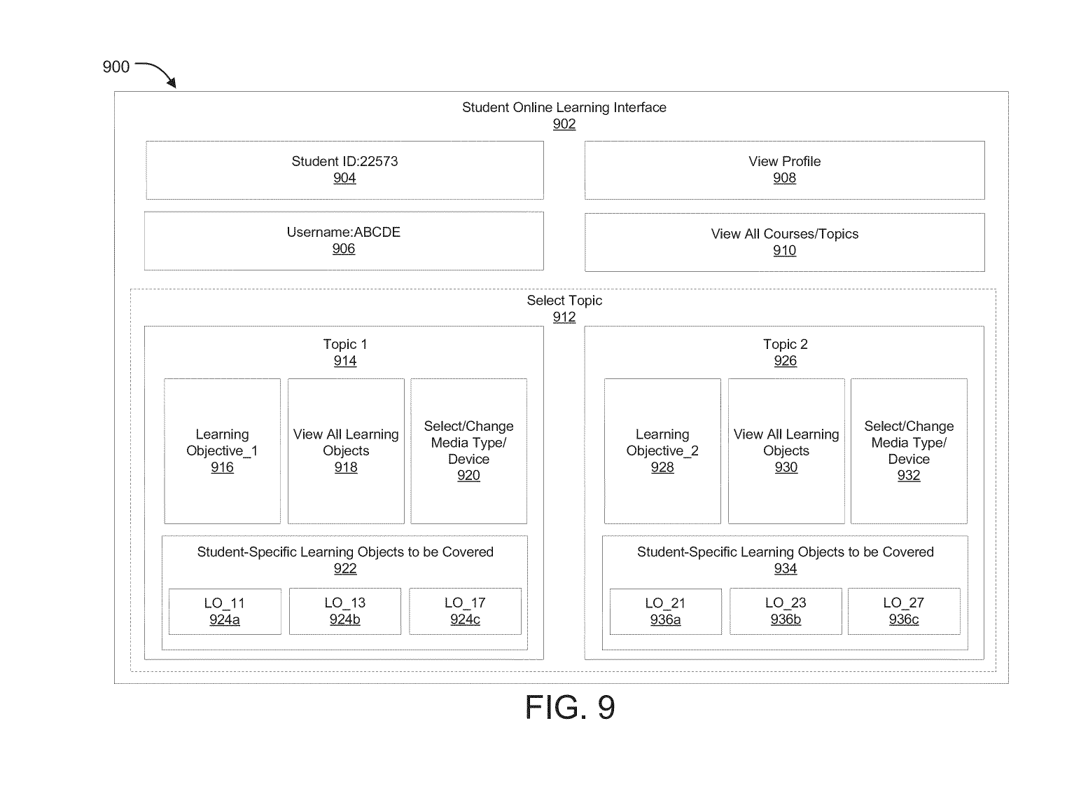

FIG. 9, with reference to FIGS. 1 through 8, illustrates an exemplary representation of student's online learning interface 900, at a client device, in accordance with an embodiment herein. Such an interface 900/902 can include student identification information such as ID 904, a username 904 that individually or in combination with student identification information 904 can uniquely identify the student 102. The student's online learning interface 902, can be configured to present one and more courses/topics that have been enrolled by the student such as Topic 1 914 and Topic 2 926. The profile of each student, which can either be automatically generated/updated or modified manually or a combination thereof, can also be viewed by the student through a view profile option 908. In addition, apart from currently relevant topics such as Topic 1 914 and Topic 2 926, all other courses/topics can also be seen at option 910. One should appreciate that the client interface shown through representation 900 is completely exemplary and any other format/representation/option/presentation can be configured in the interface based on the learning management system 106 of the embodiments herein. In an exemplary embodiment, a student 102 who may have enrolled for Topic 1 914 may intend to cover Learning Objective_1 916, which can, by default include a plurality of learning objects 918. In such a case, based on the student profile vector, the values of the attributes of the student profile vector can be multiplied with the weights of attributes of each learning object to identify a defined set of learning objects 922 that should be covered by the student 102. Such a list of student-specific learning objects 922 can include learning objects LO_11 924a, LO_13 924b, and LO_17 924c.

Similarly, in another exemplary embodiment, a student 102 who may have enrolled for Topic 2 926 may intend to cover Learning Objective_2 928, which can, by default include a plurality of learning objects 930. In such a case, based on the student profile vector, values of the attributes of the student profile vector can be multiplied with the weights of attributes of each learning object 928 to identify a defined set of learning objects 934 that should be covered by the student. Such a list of student-specific learning objects 934 can include learning objects LO_21 936a, LO_23 936b, and LO_27 936c. One should appreciate that although the interface 902 presents only filtered and top rated learning objects (922/934) to the student 102, and the student 102 may explore/view all the learning objects 918/930 by selecting this option. For example, there may be 40 learning objects for a given learning objective in totality, but a student gets only the 15 top rated or filter learning objects based on his/her profile vector.

In another embodiment, a student 102 may also select/change the media type and/or device through options 920/932 based on his/her personal preferences, wherein, in such a case, the online learning content can be formatted in the desired delivery mode accordingly before delivery. In another embodiment, online learning interface 900 can also include other objects including, but not limited to, profile pictures, quick access link to social media platforms, chat interface, forum interface, list of friends having common learning objects, file sharing interface, discussion forum and interface for user profile settings, among other like interface options/parameters.

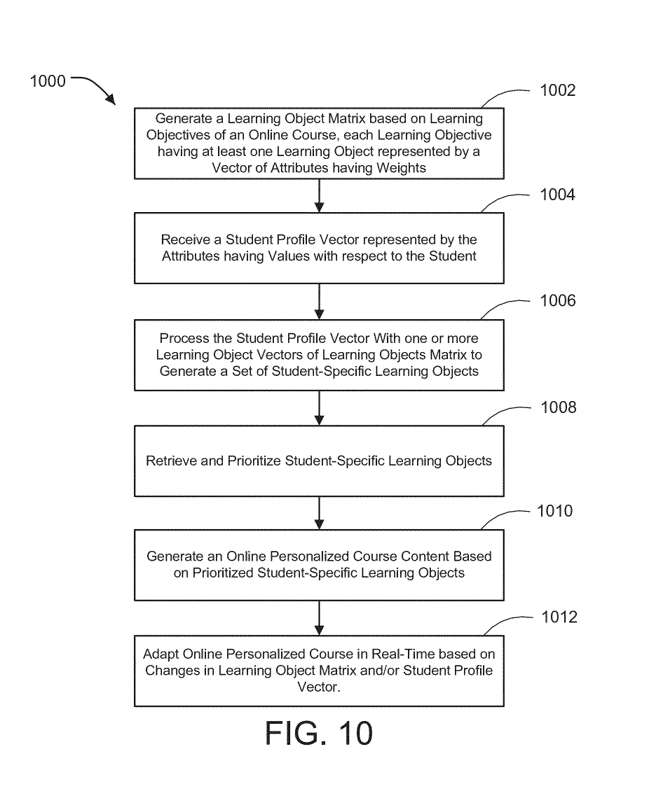

FIG. 10, with reference to FIGS. 1 through 9, illustrates an exemplary method 1000 for generation of student specific online course content 210 in accordance with an embodiment herein. In step 1002, a learning objects matrix can be generated by aggregating a plurality of learning objects of one or more learning objectives of at least one course, wherein each learning objective comprises at least one learning object, and wherein each learning object can be represented as a vector of one or more attributes having weights associated thereto for the respective learning object. Such attributes can relate of multiple learning styles, preferences, interests, learning object characteristics, prerequisite knowledge, among other factors.

At step 1004, student profile vector for a given student 102 can be received, wherein the student profile vector can be generated based on attributes representative of one or a combination of a student's demographic profile, psychographic profile, learning style, interests, prerequisite knowledge assessments, social profile, skill, and performance, and wherein the vector can include one or more of attributes along with values thereof for the student 102 in context. In an exemplary implementation, attributes based on which the student profile vector is generated can be the same or a subset of the attributes based on which one or more learning objects are represented.

At step 1006, the student profile vector can be processed with one or more learning objects of the learning objects matrix for the one or more learning objectives to generate a student-specific list of learning objects, wherein the student-specific list of learning objects can be generated based on values of the attributes of the student profile vector and weights of corresponding attributes of the learning objects vectors of the learning objects matrix. In an exemplary implementation, the processing of the student profile vector with the learning objects matrix can include multiplying the value of each attribute of the student profile vector with the weight of each corresponding attribute of learning objects of the learning objects matrix to retrieve the student-specific list of learning objects. In an exemplary embodiment, the student-specific list of learning objects can be a subset of learning objects that form part of the learning objects matrix, wherein the subset is selected based on a defined number of most relevant learning objects. For example, from a list of sixty learning objects that have been processed with respect to the student profile vector, the top ten relevant learning objects for the student 102 in context can be retrieved. In an alternate embodiment, the student-specific list of learning objects can include all learning objects that form part of the learning objects matrix.

At step 1008, the student-specific list of learning objects can be retrieved and prioritized in order to obtain a defined number of learning objects based on which the student specific online course content 210 can be generated. It should be appreciated that in case step 1006 identifies the student-specific list of learning objects as a final subset of learning objects, then step 1008 can be avoided. Also, the step of prioritization 1008, can include sorting of the learning objects based on their relevancy to the student 102 in context such that the most relevant learning object is on the top of the list of the student-specific learning objects. Alternatively, steps 1006 and 1008 can also be combined with an objective of retrieving a final set of learning objects from the total number of learning objects, wherein the final set defines the student-specific list of learning objects.

At step 1010, the student-specific list of learning objects, also interchangeably referred to as a prioritized set of learning objects, can be processed to generate the online course content 210 for the student, which can then be transmitted to client devices based on desired media/device type. At step 1012, the generated online course content 210 can be updated/modified in real-time based on a change in the student profile vector and/or one or more learning object vectors. Change(s) in student profile vector can take place by any modification in attributes or values thereof for the student 102 in context, wherein such changes can either be identified in real-time or periodically at defined time intervals. The changes can be incorporated automatically by syncing with other online profiles and activities of the student. Similarly, changes in learning objects can be identified by detecting any change in attributes that form part of the learning object vector or in weights associated with the attributes.

The embodiments herein can include both hardware and software elements. The embodiments that are implemented in software include but are not limited to, firmware, resident software, microcode, etc. For example, the microcontroller can be configured to run software either stored locally or stored and run from a remote site.

In this regard, the software elements can be stored in the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium, fixed or removable.

Input/output (I/O) devices (including but not limited to keyboards, displays, pointing devices, etc.) can be coupled to the system either directly or through intervening I/O controllers, wired or wireless. Network adapters may also be coupled to the system to enable the data processing system to become coupled to other data processing systems or remote printers or storage devices through intervening private or public networks.

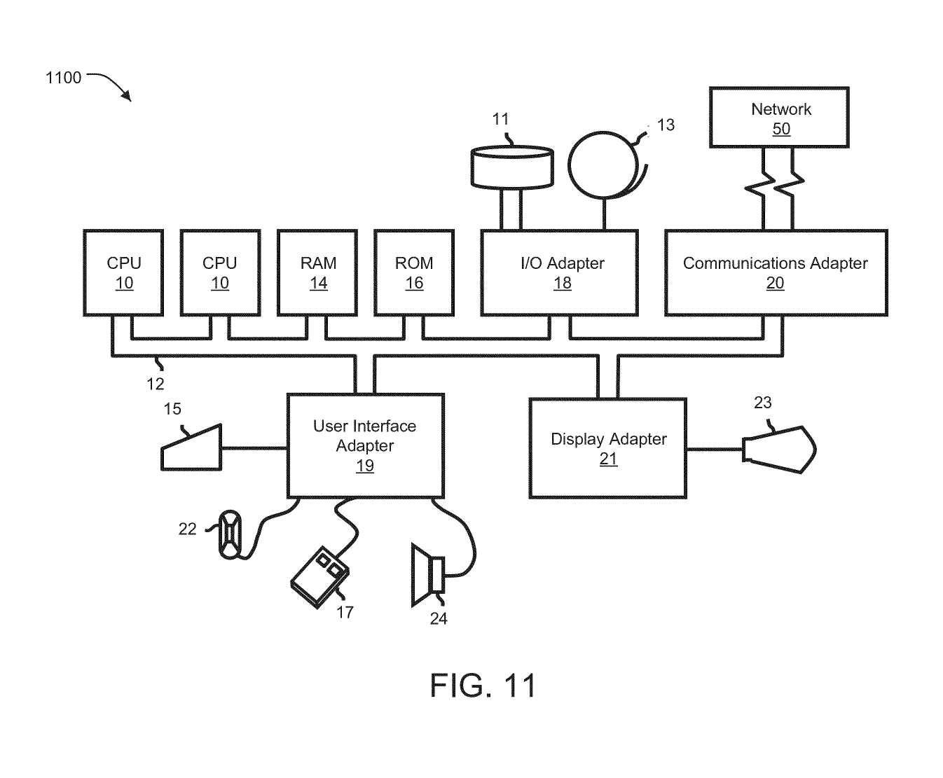

A representative hardware environment for practicing the software embodiments either locally or remotely is depicted in FIG. 11, with reference to FIGS. 1 through 10. This schematic drawing illustrates a hardware configuration of an information handling/computer system 1100 in accordance with the embodiments herein. The system 1100 comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices 11, 13, or other program storage devices that are readable by the system. The system 1100 can read the inventive instructions on the program storage devices and follow these instructions to execute the methodology of the embodiments herein. The system 1100 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for generating student-specific online course content, said method comprising:
generating an electronically represented student profile vector of a student based on attributes representative of one or a combination of a demographic profile, psychographic profile, learning style, personality traits, interests, social networking profile, social media interactions, online interaction characteristics, social networking circle attributes, prerequisite knowledge assessments, social profile, skill, and performance of said student, wherein said student profile vector comprises one or more of said attributes along with associated quantitative values thereof for said student;
generating an electronically represented learning objects matrix based on one or more learning objectives of at least one course, wherein each learning objective comprises a plurality of learning objects, and wherein each learning object comprises an electronically represented vector of one or more of said attributes along with weights thereof;
processing said student profile vector with said learning objects matrix for said one or more learning objectives to generate an electronically represented student-specific list of learning objects, wherein said student-specific list of learning objects is generated based on values of attributes of said student and weights of corresponding attributes of said learning objects of said learning objects matrix;
evaluating said student-specific list of learning objects to select a set of final learning objects from said student-specific list of learning objects;
assembling said final list of learning objects;
generating said student-specific online course content for said student based on the assembled final list of learning objects; and
delivering said student-specific online course content to said student through an online content transmission means.

2. The method of claim 1, wherein the processing of said student profile vector with said learning objects matrix comprises multiplying a value of each attribute of said student profile vector with the weight of each corresponding attribute of learning objects of said learning objects matrix to retrieve said student-specific list of learning objects.

3. The method of claim 1, further comprising delivering said student-specific online course content in one or a combination of video format, text format, and audio format.

4. The method of claim 1, further comprising presenting said student-specific online course content to said student in a format and manner defined by said student profile vector.

5. The method of claim 1, further comprising generating one or more of said plurality of learning objects based on one or a combination of inputs from third-party content providers, content from publishers, online content, shared notes of other students, core course material, supplemental content, case studies, teacher-authored material, curated material, existing literature, student feedback, dynamically retrieved stakeholder content, and dynamically generated relevant content.

6. The method of claim 1, further comprising changing said student-specific online course content in real-time based on changes in one or more of said student profile vector and said learning objects matrix.

7. The method of claim 6, further comprising computing said changes based on feedback, response, or interactions from one or a combination of students, teachers, publishers third-party evaluators, and stakeholders in said student-specific online course content generation.

8. The method of claim 1, wherein the number of attributes in each learning object that is processed with said student profile vector is the same as the number of attributes in said student profile vector.

9. The method of claim 1, wherein one or more learning objects of said learning objective have different number of attributes.

10. The method of claim 1, wherein the weight of each attribute across learning objects is equal.

11. The method of claim 1, wherein the weight of each attribute across learning objects is different.

12. The method of claim 1, further comprising continuously updating the weights of attributes of learning objects for matching between vectors of said learning objects and said student profile vector.

13. The method of claim 1, wherein the weight of each attribute for said learning object is based on a relevance of said attribute for said learning object.

14. The method of claim 1, wherein the assembling of said final list of learning objects comprises processing a subset of said final list of learning objects.

15. The method of claim 1, further comprising identifying said learning objectives based on relevance of tasks in a current course, tasks in a previous courses, performance of one or more students in said courses, and interest of one or more students in said courses.

16. The method of claim 1, wherein the delivering of said student-specific online course content to said student comprises encrypting said student-specific online course content before transmission to student terminal.

17. The method of claim 1, further comprising delivering said student-specific online course content to one or more communication devices comprising a mobile phone, tablet computer, personal computer, smart phone, laptop, and display-enabled computing device.

18. The method of claim 1, further comprising sorting said student-specific list of learning objects to obtain said final list of learning objects.

19. The method of claim 1, further comprising authorizing said student before delivering said student-specific online course content.

20. The method of claim 1, wherein said student forms part of a group of students, and wherein said student-specific online course content is delivered to said group of students.

21. A system for generating and delivering student-specific online course content for a student, said system comprising:
a student profile vector generation module that generates an electronically represented student profile vector of said student based on attributes representative of one or a combination of a demographic profile, psychographic profile, learning style, personality traits, interests, social networking profile, social media interactions, online interaction characteristics, social networking circle attributes, prerequisite knowledge assessments, social profile, skill, and performance of said student, wherein said student profile vector comprises one or more of said attributes along with associated quantitative values thereof for said student;
a first database that stores said student profile vector;
an electronically represented learning object matrix creation module that creates a learning objects matrix based on one or more learning objectives of at least one course, wherein each learning objective comprises a plurality of learning objects, and wherein each learning object comprises an electronically represented vector of one or more of said attributes along with weights thereof;
a second database that stores said learning objects matrix;
a processing module that processes said student profile vector retrieved from said first database with said learning objects matrix retrieved from said second database for said one or more learning objectives to generate a student-specific list of learning objects, wherein said student-specific list of learning objects is generated based on values of attributes of said student and weights of corresponding attributes of said learning objects of said learning objects matrix; and
a course content generation module that generates said student-specific online course content for said student based on said student-specific list of learning objects, and delivers said student-specific online course content to said student at a client device through an online content transmission means.

22. The system of claim 21, further comprising a prioritization module that selects one or more learning objects from said student-specific list of learning objects to generate said student-specific online course content, wherein said one or more learning objects are selected based on one or a combination of relevance of said learning objects to said student and number of learning objects to be incorporated for generation of said student-specific online course content.

23. The system of claim 21, wherein said processing module multiplies a value of each attribute of said student profile vector with weight of each corresponding attribute of learning objects of said learning objects matrix to retrieve said student-specific list of learning objects.

24. The system of claim 21, wherein said student-specific online course content is delivered in one or a combination of video format, text format, and audio format.

25. The system of claim 21, wherein said student-specific online course content is presented to said student in a format and manner defined based on said student profile vector.

26. The system of claim 21, wherein one or more of said plurality of learning objects are generated based on one or a combination of inputs from third-party content providers, content from publishers, online content, shared notes of other students, core course material, supplemental content, case studies, teacher-authored material, curated material, existing literature, student feedback, dynamically retrieved stakeholder content, and dynamically generated relevant content.

27. The system of claim 21, wherein said student-specific online course content is adapted in real-time based on changes in one or more of said student profile vector and said learning objects matrix.

28. The system of claim 27, wherein said changes are computed based on feedback, response, or interactions from one or a combination of students, teachers, publishers third-party evaluators, and stakeholders in said student-specific online course content generation.

29. The system of claim 21, wherein number of attributes in each learning object that is processed with said student profile vector is the same as the number of attributes in said student profile vector.

30. The system of claim 21, wherein one or more learning objects of said learning objective have different number of attributes.

31. The system of claim 21, wherein the weight of each common attribute across learning objects is equal.

32. The system of claim 21, wherein the weight of each attribute across learning objects is different.

33. The system of claim 21, wherein weights of attributes of learning objects are continuously updated for matching between vectors of said learning objects and said student profile vector.

34. The system of claim 21, wherein the weight of each attribute for said learning object is based on a relevance of said attribute for said learning object.

35. The system of claim 21, wherein said student-specific online course content delivered to said student is encrypted before transmission to said client device.

36. The system of claim 21, wherein said student-specific online course content is delivered to one or more communication devices comprising mobile phone, tablet electronic device, personal computer, smart phone, laptop, and display-enabled computing device.

37. The system of claim 21, wherein said student is authenticated prior to delivering said student-specific online course content.

38. A method for creating adaptive student-specific online course content, said method comprising:
generating an electronically represented student profile vector of a student based on attributes representative of one or a combination of a demographic profile, psychographic profile, learning style, personality traits, interests, social networking profile, social media interactions, online interaction characteristics, social networking circle attributes, prerequisite knowledge assessments, social profile, skill, and performance of said student, wherein said student profile vector comprises one or more of said attributes along with associated quantitative values thereof for said student;
generating an electronically represented learning objects matrix based on one or more learning objectives of at least one course, wherein each learning objective comprises a plurality of learning objects, wherein each learning object comprises an electronically represented vector of one or more of said attributes along with weights thereof, and wherein said plurality of learning objects are selected based on one or a combination of inputs from third-party content providers, content from publishers, online content, shared notes of other students, core course material, supplemental content, case studies, teacher-authored material, curated material, existing literature, student feedback, dynamically retrieved stakeholder content, and dynamically generated relevant content;
processing said student profile vector with said learning objects matrix for said one or more learning objectives to generate an electronically represented student-specific list of learning objects, wherein said student-specific list of learning objects is generated based on values of attributes of said student and weights of corresponding attributes of said learning objects of said learning objects matrix;
generating said student-specific online course content for said student based on said student-specific list of learning objects;
adapting and updating said student-specific online course content based on one or a combination of changes in said values of said attributes for said student profile vector and changes in said weights of said attributes for learning objects of said learning objects matrix; and
presenting said student-specific online course content through a communications network.

39. The method of claim 38, wherein the adapting and updating of said student-specific online course content occurs in real-time.

40. The method of claim 38, wherein the adapting and updating of said student-specific online course content occurs over a period of time based on a regression analysis of weights associated with one or more learning objects of at least one learning objective of one or more courses.

41. The method of claim 38, wherein the adapting and updating of said student-specific online course content occurs over a period of time based on machine learning implementation on student-specific list of learning objects associated with a plurality of students.
